(19) United States
(12) Patent Application Publication
(10) Pub. No.: US 2016/0164786 A1
(43) Pub. Date: Jun. 9, 2016

(54) COMMUNICATION SYSTEM

(71) Applicant: NEC CORPORATION, Tokyo (JP)

(72) Inventor: MISAO FUKUDA, Tokyo (JP)

(21) Appl. No.: 14/900,865

(22) PCT Filed: Jun. 20, 2014
(86) PCT No.: PCT/JP2014/003317

§ 371 Date: Dec. 22, 2015

(30) Foreign Application Priority Data
Jul. 2, 2013 (JP) 2013-138676

(51) Int. Cl. H04L 12/803; H04L 12/703; H04L 12/721

(52) U.S. Cl. CPC H04L 47/122; H04L 45/38; H04L 45/28

(57) ABSTRACT

In a communication system, a plurality of segments are formed. The plurality of segments each include: a communication path instruction device instructing establishment of a communication path in a network; the network in which a communication path is established by the communication path instruction device; and an information acquisition unit acquiring network information of the network. The networks of the respective segments are connected to each other via a network connection device. The communication system has: an information aggregation unit aggregating a plurality of network information acquired by the information acquisition units; and a higher-level communication path instruction unit instructing establishment of a path in each of the networks of the respective segments. The higher-level communication path instruction unit instructs establishment of a communication path passing through the networks by using the information aggregated by the information aggregation units.

### TECHNICAL FIELD

The present invention relates to a communication system, an information aggregation device, an information processing method, and a program. More specifically, the present invention relates to a communication system controlling a wide-range network, an information aggregation device, an information processing method, and a program.

### BACKGROUND ART

OpenFlow is known as one of the techniques for realizing SDN (Software-Defined Networking), which manages a network with software (see Patent Document 1, for example).

OpenFlow is configured by an OpenFlow controller and an OpenFlow switch. The OpenFlow controller sets a process of control of packets received by the OpenFlow switch, and notifies the set control process to the OpenFlow switch. The OpenFlow switch controls packets on the basis of the control process notified by the OpenFlow controller.

To be specific, for example, in a case where a control method corresponding to packets received from a terminal device is preset, the OpenFlow switch controls packets received from a terminal device in accordance with the preset control method when receiving the packets. On the other hand, in a case where a control method corresponding to received packets is not preset, the OpenFlow switch contacts the OpenFlow controller to inquire the control method and process the packets.

Thus, the OpenFlow switch processes received packets on the basis of a preset processing method. Therefore, the behavior of the OpenFlow switch (how to process packets) can be changed by changing the setting of a method of control by the OpenFlow controller. Consequently, a network can be managed with software (program).

### Patent Document 1: International Publication WO/2010/103909

As stated above, the behavior of the OpenFlow switch can be managed with the OpenFlow controller. However, for example, it is not realistic to manage everywhere in Japan with a single OpenFlow controller. Then, one OpenFlow controller is placed in every range (every segment) in which the OpenFlow controller can manage OpenFlow switches, and the OpenFlow controller in each segment manages the OpenFlow switches in the segment corresponding to the OpenFlow controller.

As stated above, the OpenFlow controller in each segment manages only the OpenFlow switches in the segment corresponding to the OpenFlow controller. Therefore, for example, when it is intended to perform communication across a plurality of segments, an OpenFlow controller in a certain segment cannot obtain information for controlling OpenFlow switches outside a range where the OpenFlow controller can control (i.e., outside the segment corresponding to the OpenFlow controller), and cannot control the OpenFlow switches outside the segment. That is to say, when it is intended to perform communication passing through a plurality of segments, the OpenFlow controller cannot manage OpenFlow switches outside the segment to which the OpenFlow controller belongs, and cannot calculate a proper path.

Because the OpenFlow controller cannot acquire information about the outside of the segment where the OpenFlow controller belongs and therefore cannot manage OpenFlow switches outside the segment where the OpenFlow controller belongs, there is a problem that in a case where the OpenFlow controller needs to calculate a path across a plurality of segments, the OpenFlow controller cannot calculate a proper path.

### SUMMARY

Accordingly, an object of the present invention is to provide a communication system which can solve the abovementioned problem that in a case where an OpenFlow controller needs to calculate a path across a plurality of segments, the OpenFlow controller cannot calculate a proper path.

In order to achieve the object, in a communication system as an aspect of the present invention:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device.

The communication system has:

an information aggregation unit aggregating a plurality of the network information acquired by information acquisition units of the respective segments; and

a higher-level communication path instruction unit instructing establishment of a path in each of the networks of the respective segments.

The higher-level communication path instruction unit instructs establishment of a communication path passing through the networks by using the information aggregated by the information aggregation units.

Further, an information aggregation device as another aspect of the present invention is used in a state that:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device.

The information aggregation device includes:

an information aggregation unit aggregating a plurality of the network information acquired by information acquisition units of the respective segments; and

an aggregated information provision unit providing the aggregated network information to a higher-level communication path instruction unit instructing each of the networks of the respective segments to establish a communication path passing through the networks.

Further, an information processing method as another aspect of the present invention is an information processing method in a state that:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device.

The information processing method includes:

aggregation by an information aggregation unit, the aggregation being aggregating the network information from the networks of the respective segments; and

instruction by a communication path instruction device, the instruction being instructing establishment of a communication path passing through the networks by using the aggregated network information.

Further, a program as another aspect of the present invention is a computer program having instructions for causing an information aggregation device to realize:

an information aggregation unit aggregating network information of networks of respective segments; and

an aggregated information provision unit providing the aggregated network information to a higher-level communication path instruction unit instructing each of the networks of the respective segments to establish a communication path passing through the networks.

With the configurations as described above, the present invention makes it possible to calculate a proper path passing through a plurality of segments in a case where an OpenFlow controller needs to calculate a path across a plurality of segments.

### BRIEF DESCRIPTION OF DRAWINGS

FIG. 1 is a diagram showing the configuration of a communication system in a first exemplary embodiment of the present invention;

FIG. 2 is a block diagram showing the function of an information processing unit in the first exemplary embodiment of the present invention;

FIG. 3 is a block diagram showing the configuration of a virtual machine control part shown in FIG. 2;

FIG. 4 is a block diagram showing the configuration of each terminal device shown in FIG. 1;

FIG. 5 is a block diagram showing the configuration of an OpenFlow switch shown in FIG. 1;

FIG. 6 is a diagram illustrating a flow table used by the OpenFlow switch;

FIG. 7 is a block diagram showing the configuration of an external WAN server shown in FIG. 1;

FIG. 8 is a diagram showing with arrows the flow of information in the communication system in the first exemplary embodiment of the present invention;

FIG. 9 is a flowchart showing processing operation by the OpenFlow switch;

FIG. 10 is a sequence diagram illustrating address resolution by the information processing unit;

FIG. 11 is a flowchart illustrating a flow entry acquisition process by an OpenFlow controller function part;

FIG. 12 is a flowchart illustrating the flow entry acquisition process shown in FIG. 11;

FIG. 13 is a diagram showing with arrows the flow of information in the first exemplary embodiment;

FIG. 14 is a diagram showing the configuration of a communication system in a second exemplary embodiment;

FIG. 15 is a block diagram showing the configuration of an external WAN server in the second exemplary embodiment;

FIG. 16 is an example of path selection by a segment selection function part shown in FIG. 15;

FIG. 17 is a diagram showing with arrows the flow of information in the second exemplary embodiment;

FIG. 18 is a diagram showing with arrows the flow of information in the second exemplary embodiment;

FIG. 19 is a diagram showing the configuration of a modified example of the second exemplary embodiment;

FIG. 20 is a block diagram showing with arrows the flow of information in the modified example of the second exemplary embodiment;

FIG. 21 is a block diagram showing with arrows the flow of information in the modified example of the second exemplary embodiment;

FIG. 22 is a diagram showing the configuration of a communication system in a third exemplary embodiment;

FIG. 23 is a block diagram showing the configuration of an external WAN server in the third exemplary embodiment;

FIG. 24 is a diagram showing with arrows the flow of information in the third exemplary embodiment;

FIG. 25 is a diagram showing with arrows the flow of information in the third exemplary embodiment; and

FIG. 26 is a block diagram showing the function of an information processing unit in a fifth exemplary embodiment.

### EXEMPLARY EMBODIMENTS

### First Exemplary Embodiment

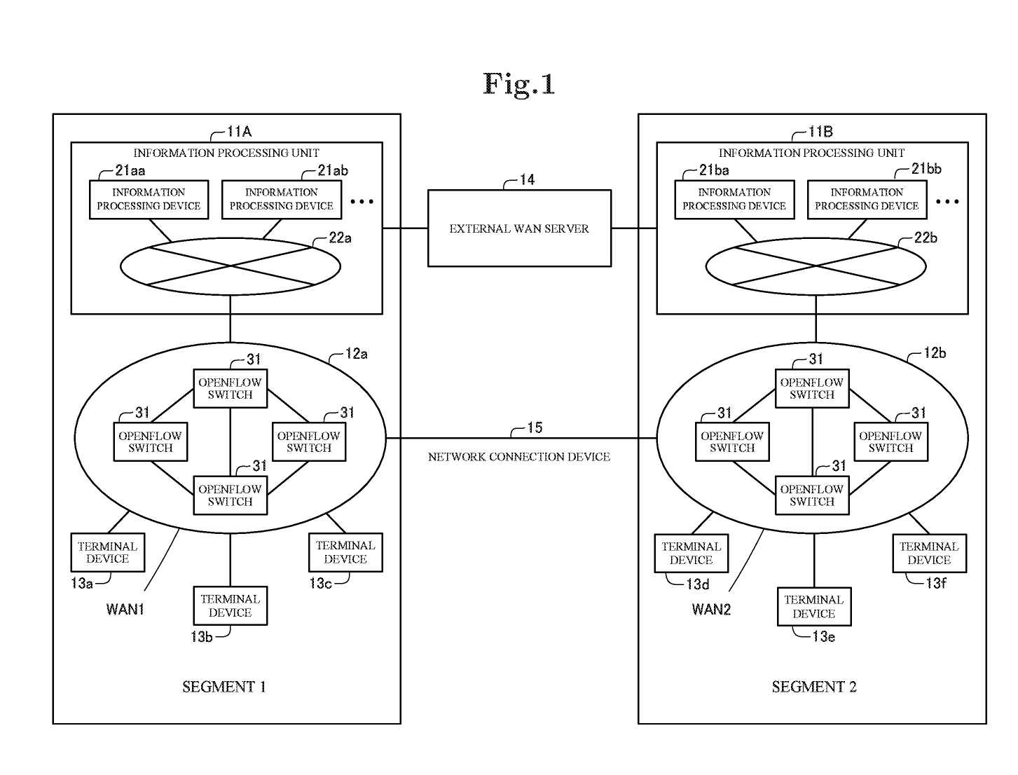

A first exemplary embodiment of the present invention will be described with FIGS. 1 to 13.

### (Configuration)

The number of OpenFlow switches (network devices) which a single OpenFlow controller (a communication path instruction device) can manage is limited. Thus, a range in which a single OpenFlow controller manages will be referred to as a segment. The first exemplary embodiment shows a case of two segments. That is to say, a case where there are two segments and establishment of a communication path across the two segments is required will be described in the first exemplary embodiment. In this exemplary embodiment, as described later, an OpenFlow controller (a communication path instruction device) in a certain segment serves as a higher-level communication path instruction device and instructs establishment of a communication path across two segments by using information aggregated by an information aggregation unit to be described later. Although this exemplary embodiment shows the case of two segments, the present invention can be practiced independent of the number of segments.

First, an overall configuration in this exemplary embodiment will be described.

As shown in FIG. 1, a communication system in this exemplary embodiment is configured by two segments (a segment 1 and a segment 2) and an external WAN server 14 (an information aggregation unit). Each of the segments is a range managed by a single OpenFlow controller (a communication path instruction device, an information processing unit) at an ordinary time. The external WAN server 14 is located outside the two segments and collects information on networks within the two segments. The two networks, or the networks located in the respective segments to be described later, are connected by a network connection device 15.

First, an information processing unit 11A will be described. The information processing unit 11A serves as an OpenFlow controller in this exemplary embodiment. The information processing unit 11A includes a plurality of information processing devices which are distributed on the cloud. That is to say, the information processing unit 11A includes a plurality of information processing devices 21aa, 21ab, . . . (hereinafter, the information processing devices will be each referred to as an information processing device 21 when not distinguished from each other. It is also true for other components). The information processing devices 21 are connected so as to be capable of communicating via a network 22a within the information processing unit 11A. In this exemplary embodiment, each of the information processing devices 21 is made up by a blade server, and it is possible to increase the number thereof as necessary. The information processing unit 11A includes a plurality of information processing devices 21 in the above description, but may be made up by a single information processing device 21 (e.g., the information processing device 21aa). That is to say, the single information processing device 21 may have a configuration for realizing each function part of the information processing unit 11 to be described later. Likewise, another information processing unit 11B to be described below may also be made up by a single information processing device 21.

The information processing unit 11B includes a plurality of information processing devices 21ba, 21bb, . . . as the information processing unit 11A does. The information processing devices 21ba, 21bb, . . . are connected so as to be capable of communicating via a network 22b within the information processing unit 11B. That is to say, the information processing devices 21ba, 21bb, . . . included by the information processing unit 11B are placed in a different network from the information processing devices 21aa, 21ab, . . . included by the information processing unit 11A are. Although the information processing unit 11A will be described hereinafter, the information processing unit 11B has the same configuration.

Each of the information processing devices 21 is configured to be capable of building a plurality of virtual machines (virtual servers). To be specific, each of the information processing devices 21 executes a program serving as a main operating system (a main OS). Then, each of the information processing devices 21 executes, on the main OS, a virtual machine program serving as a program for making the virtual machines work. Additionally, each of the information processing devices 21 executes at least one subsidiary OS (a guest OS) on the virtual machine program. Moreover, each of the information processing devices 21 executes at least one application program on each guest OS. The guest OS executed by each of the information processing devices 21 makes up a virtual machine. Each virtual machine implements one of function parts to be described later.

Next, a terminal device 13 will be described. Each of a plurality of terminal devices 13 (terminal devices 13a, 13b, 13c, 13d, . . . shown in FIG. 1) is, for example, a personal computer, a smartphone, or the like. Each of the terminal devices may be a mobile phone terminal, a PHS (Personal Handy-phone System), a PDA (Personal Data Assistance, Personal Digital Assistant), a car navigation terminal, a game terminal, or the like.

Of the plurality of terminal devices described above, the terminal devices 13a, 13b and 13c are terminal devices located in the segment 1. That is to say, in this exemplary embodiment, the terminal devices 13a, 13b and 13c are connected, via a network 12a (e.g., WAN (Wide Area Network)) within the segment 1, to the network 22a which is within the information processing unit 11A placed in the segment 1 and is different from the network 12a. The terminal devices 13d, 13e and 13f are terminal devices located in the segment 2. In the same manner as the terminal devices located in the segment 1, the terminal devices 13d, 13e and 13f are connected, via a network 12b (e.g., also WAN) within the segment 2, to the network 22b which is within the information processing unit 11B placed in the segment 2 and is different from the network 12b. Although a case where three terminal devices 13 are connected to each of the networks (12a and 12b) is illustrated in FIG. 1, the present invention can be practiced independent of the number of the terminal devices 13. The present invention can be practiced even if only one terminal device 13 is connected to each of the networks, or even if four or more terminal devices 13 are connected to each of the networks.

Next, the networks 12a and 12b will be described. The networks 12a and 12b each include a plurality of OpenFlow switches 31 (network equipment) which can be connected to each other. The networks 12a and 12b are different networks from the networks 22a and 22b within the information processing units 11A and 11B. The networks 12a and 12b are connected to the networks 22a and 22b, respectively. Each of the networks 12a and 12b and the networks 22a and 22b is made up by a communication network such as an IP (Internet Protocol) network.

Further, as stated above, the network 12a and the network 12b are connected to each other by, for example, the network connection device 15 (a high-capacity switch, or the like). To be specific, the network 12a and the network 12b are connected by one network connection device 15 in a case where the segment 1 and the segment 2 belong to the same telecommunications carrier, whereas the network 12a and the network 12b are connected by two network connection devices 15 in a case where the segment 1 and the segment 2 belong to different telecommunication carriers from each other.

Next, the external WAN server 14 will be described. The external WAN server 14 (an information aggregation unit) is placed outside, not belonging to any of the abovementioned two segments. For example, the external WAN server 14 is placed on the cloud. The external WAN server 14 is a server which aggregates information of the networks (12a and 12b) acquired by an administrator (an information acquisition unit) included by each of the information processing units 11A and 11B to be described later. Therefore, the external WAN server 14 has a DB (DataBase) to be described later. Although an external server (an external WAN server) is used as the information aggregation unit in this exemplary embodiment, there is no need to always use an external server in the practice of the present invention. For example, it can be conceived that an administrator function part 42 within one information processing unit 11 communicates as necessary with a DB to be described later included by an information processing unit 11 of another segment via an administrator function part 42 in the information processing unit 11 of the other segment and thereby acquires network information of the other segment. Acquisition of the network information of the other segment by the abovementioned method enables aggregation of the network information of the other segment, and the present invention can also be practiced by using the aggregated network information. That is to say, the present invention can be practiced as far as information of networks can be aggregated in a plurality of segments by any means.

As stated before, it is not realistic that a single OpenFlow controller controls all OpenFlow switches. Thus, a range in which a single OpenFlow controller manages a plurality of OpenFlow switches has been defined as a segment. As a result, for example, an OpenFlow controller within the segment 1 manages only OpenFlow switches within the segment 1. Therefore, the segment 1 stores only information on the network 12a, which is a network within the segment 1. That is to say, the segment 1 does not have information on the network within the segment 2. Therefore, the OpenFlow controller within the segment 1 cannot manage the OpenFlow switches within the segment 2. Then, information of the networks 12a and 12b within the segments 1 and 2 is aggregated into the external WAN server, and thereby, the OpenFlow controller within the segment 1 is also allowed to acquire information of the network within the segment 2. As a result, it is possible to establish a communication path passing through the other segment.

Next, the detailed configuration of this exemplary embodiment will be described.

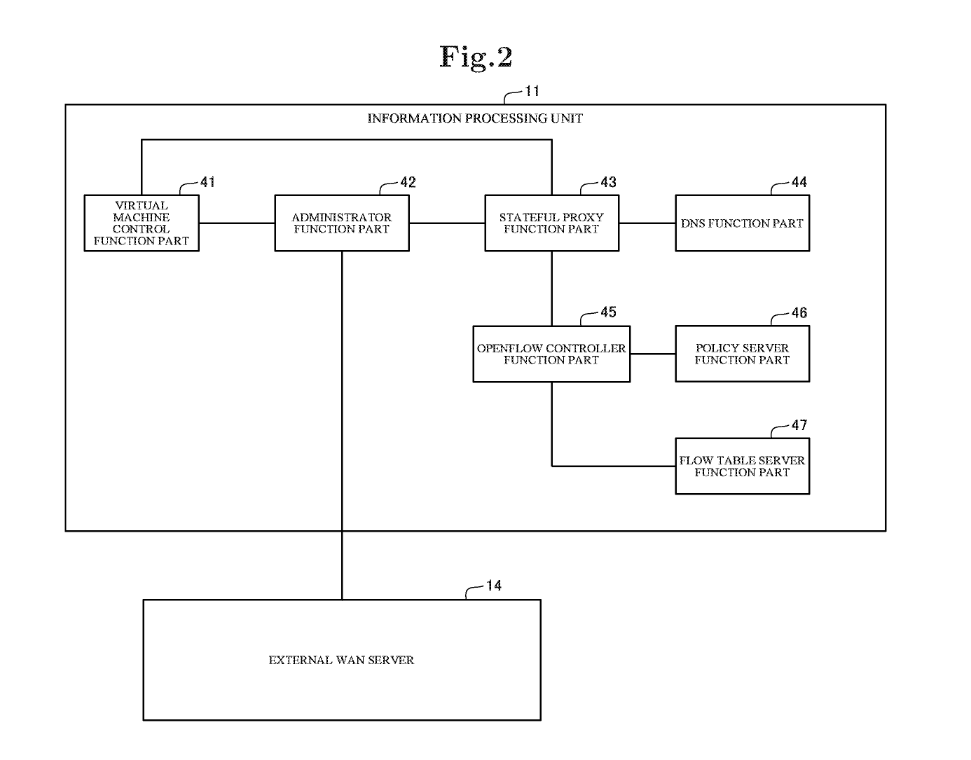

First, referring to FIG. 2, the configuration of the information processing unit 11A will be described. As shown in FIG. 2, the information processing unit 11A includes a virtual machine control function part 41, an administrator function part 42 (an information acquisition unit), a stateful proxy function part 43, a DNS (Domain Name (Naming) System (Server)) function part 44, an OpenFlow controller function part 45 (a communication path instruction device), a policy server function part 46 (the communication path instruction device), and a flow table server function part 47 (the communication path instruction device). As stated above, the respective function parts (e.g., the OpenFlow controller function part 45) within the information processing unit 11A may be configured by a single information processing device 21, or may be configured by a plurality of information processing devices 21. The configuration of the information processing unit 11B is identical to the configuration of the information processing unit 11A.

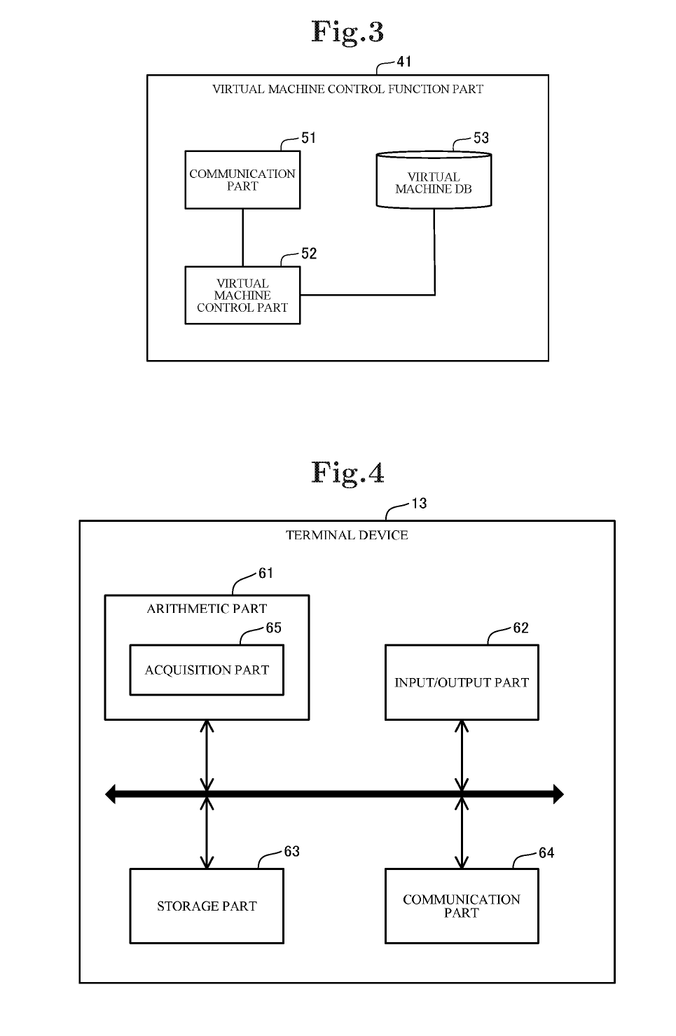

The virtual machine control function part 41 generates and controls a virtual machine within the information processing unit 11 and a virtual machine for the terminal device 13. To be specific, as shown in FIG. 3, the virtual machine control function part 41 includes a communication part 51, a virtual machine control part 52, and a virtual machine DB (DataBase) 53.

The administrator function part 42 is a part which monitors a network controlled thereby (a network in the same segment). For example, every time the network managed by the administrator function part 42 is changed, the administrator function part 42 sends information about that to the external WAN server 14 to be described later. Information transmitted by the administrator function part 42 is, for example, topology information, flow table information, and so on. Various kinds of information can be acquired from the controlled network. In this exemplary embodiment, the administrator function part 42 of each of the segments acquires information (topology information, flow table information, and so on) of the network (12a, 12b) to which the administrator function part 42 belongs, and transmits the acquired information to the external WAN server 14. Further, the administrator function part 42 has the following function; upon figuring out that communication via a plurality of segments is intended, transmitting communication destination information and transfer setting information, which will be described later, acquired by the administrator function part 42 to the external WAN server 14 in order to calculate a path passing through the plurality of segments. Furthermore, the administrator function part 42 also has a function of transmitting setting completion information of an OpenFlow switch, which will be described later, to the external WAN server 14 via the administrator function part 42. Transmission and reception of information by the administrator function part 42 and the external WAN server 14 enables calculation of a path passing through a plurality of segments.

The stateful proxy function part 43 and the DNS function part 44 are configured by, for example, a SIP (Session Initiation Protocol) server. The stateful proxy function part 43 and the DNS function part 44 are parts which control connection between a plurality of user terminals. For example, in execution of address resolution in the same segment, the stateful proxy server function part 43 and the DNS function part 44 are used. To be specific, upon acquiring communication destination information to be described later, the stateful proxy function part 43 transfers the acquired communication destination information to the DNS function part 44. Then, the DNS function part 44 acquires a communication destination address (e.g., an IP address) stored in association with the received communication destination information, and transfers the communication destination address to the stateful proxy function part 43. Through the operation described above, address resolution to be described later is executed. Besides, the stateful proxy function part 43 works, for example, when network resolution to be described later is executed.

The OpenFlow controller function part 45 is a part which designs a communication path in the network 12a. That is to say, the OpenFlow controller function part 45 executes a communication path instruction process, which is instructing the OpenFlow switches 31 placed in the network 12a to establish a communication path in the network 12a. To be specific, in a case where a new process becomes necessary, for example, in a case where a process which cannot be handled with flow tables stored in the OpenFlow switches 31 to be described later becomes necessary, the OpenFlow controller function part 45 generates a flow entry which is necessary when the OpenFlow switches 31 transfer information by using transfer setting information, and so on.

The policy server function part 46 is a part which stores policy information for setting a path within the network 12. Policy information is a rule for ensuring information security in an organization such as a company. Policy information includes information such as ID, port number, access restriction, and connection destination which preferentially connects.

The flow table server function part 47 is a part which stores a flow entry for giving a path to the OpenFlow switches 31. The flow entry generated by the OpenFlow controller function part 45 is managed by the flow table server function part 47 described above.

With the configuration described above, the information processing unit 11A realizes the function of the OpenFlow controller on the cloud. Further, the information processing unit 11A provides a thin client environment (e.g., DaaS (Desktop as a Service)) via the virtual machine control function part 41 to the terminal device 13 accessing the information processing unit 11A. That is to say, all the processing by the OpenFlow controller is executed on the information processing unit, and therefore, the terminal device 13 accessing the information processing unit 11A can perform communication using a path obtained by path calculation, without executing processing on the terminal device 13.

Next, the configuration of the terminal device 13 will be described with FIG. 4. As stated above, the terminal device 13 utilizes a virtual machine provided by the virtual machine control function part 41. As shown in FIG. 4, the terminal device 13 includes an arithmetic part 61, an input/output part 62, a storage part 63, and a communication part 64. The arithmetic part 61 has a function of an acquisition part 65 by executing a program previously stored in the storage part 63. The acquisition part 65 has a function of acquiring terminal identification information. When the virtual machine control function part 41 receives the terminal identification information, the virtual machine control function part 41 thereby authenticates the terminal device 13. As stated above, the terminal device 13 is a device which utilizes a thin client environment (e.g., DaaS (Desktop as a Service) provided by the virtual machine control function part 41. Therefore, the terminal device 13 may include at least the arithmetic device 61 such as a CPU (Central Processing Unit), the input/output device 62, and the communication part 64.

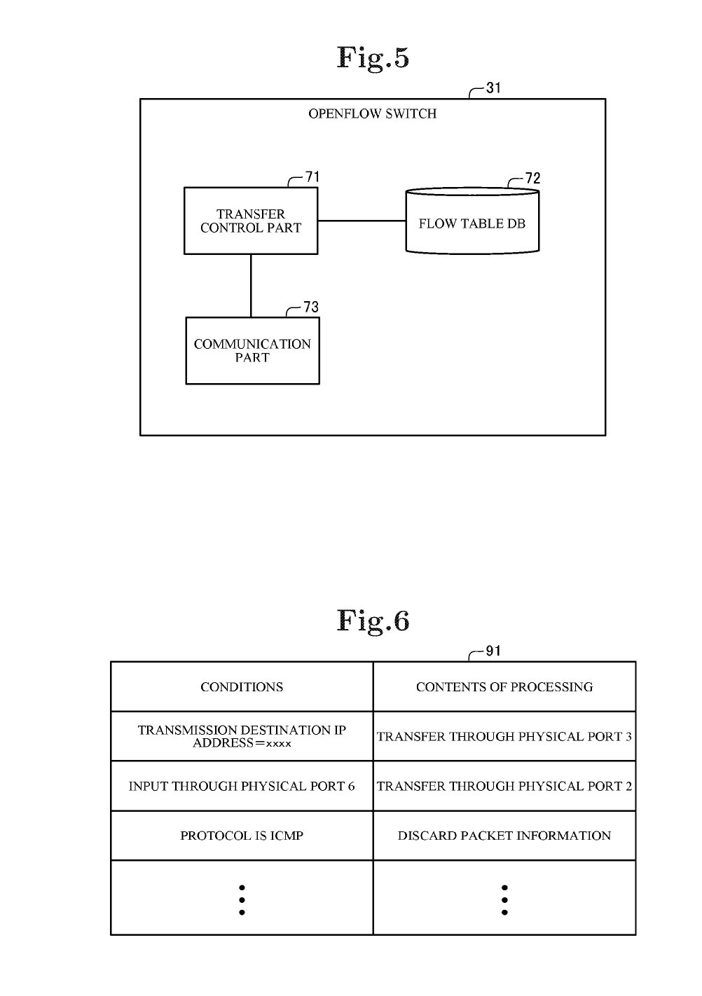

Next, referring to FIG. 5, the configuration of the OpenFlow switch 31 will be described. As shown in FIG. 5, the OpenFlow switch 31 includes a transfer control part 71, a flow table DB 72, and a communication part 73. The flow table DB 72 is a database which stores flow entries describing conditions for communication control, and is made up by a storage device such as a memory and a hard disk. That is to say, flow entries stored in the flow table DB 72 are information stored by execution of the communication path instruction process by the OpenFlow controller function part 45. The transfer control part 71 is a part which transfers packet information on the basis of a flow table stored in the flow table DB 72. The communication part 73 is a part used at the time of inquiry to the information processing unit 11 to be described later or in transmission of a setting completion notice to be described later. That is to say, the OpenFlow switch 31 exchanges various kinds of information to be described later with the information processing unit 11A via the communication part 73.

FIG. 6 is a diagram showing an example of a flow table 91 stored in the flow table DB 72. As shown in FIG. 6, “conditions” are associated with “contents of processing” in the flow table 91. Each row in the flow table 91 shows a flow entry. In the example shown in FIG. 6, when receiving packet information that a transmission destination IP address is “xxxx,” the transfer control part 71 transfers (transmits) the received packet information through a physical port 3. Further, when there is an entry of packet information through a physical port 6 of the OpenFlow switch 31, the transfer control part 71 transfers the packet information through a physical port 2. Furthermore, in a case where a protocol included in received packet information is “ICMP (Internet Control Message Protocol,” the transfer control part 71 discards the received packet information. Thus, the transfer control part 71 executes a transfer process based on each flow entry of the flow table 91, and therefore, can transfer packet information quickly and easily.

On the other hand, when a flow entry corresponding to information on performing transfer is not stored, the OpenFlow switch 31 send an inquiry how to handle to the information processing unit 11A having the function of the OpenFlow controller. When receiving the inquiry, the information processing unit 11A generates a flow entry through operation to be described later, and transmits the flow entry to the OpenFlow switch 31. Upon receiving the flow entry, the OpenFlow switch 31 sets the flow entry into the flow table (transfer setting). Then, when transfer setting is complete, the OpenFlow switch 31 transmits a setting completion notice to the external WAN server 14 via the administrator function part 42 within the information processing unit 11A. After receiving setting completion notices from all the OpenFlow switches 31 that are the target of setting, the external WAN server 14 sends a communication start instruction to a terminal which is to perform communication and the OpenFlow switch 31 to be used in the communication, via the administrator function part 42 within the information processing unit 11A. That activity allows the OpenFlow switch 31 to be used in communication to properly process packets to be transmitted in the communication.

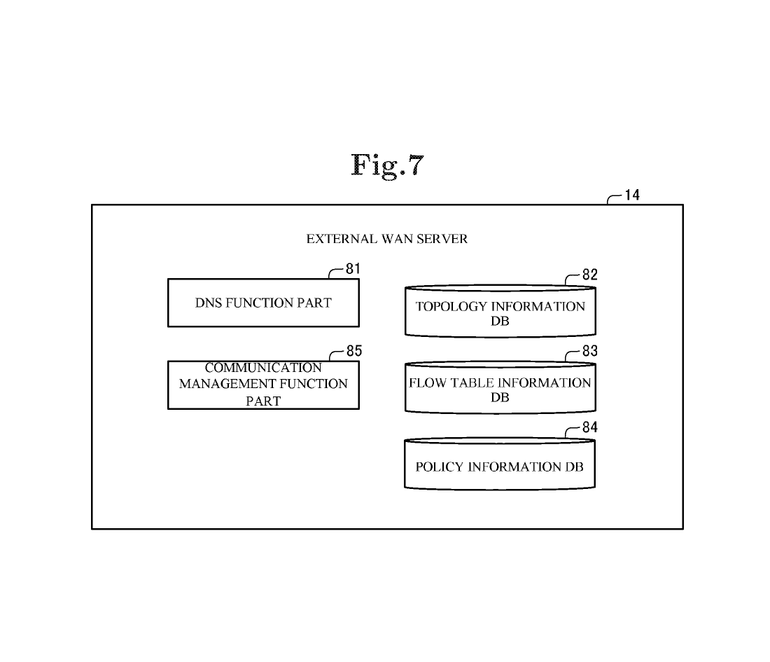

Next, referring to FIG. 7, the configuration of the external WAN server 14 will be described. The external WAN server 14 is a server which aggregates information of the segments 1 and 2. In this exemplary embodiment, as stated above, the external WAN server 14 is placed outside, not belonging to either the segment 1 or the segment 2. As described later, the information processing unit 11A, which serves as a higher-level communication path instruction unit in this exemplary embodiment, calculates a path across the segments by using the information aggregated by the external WAN server 14. Therefore, the external WAN server 14 is structured so as to be capable of storing information which is necessary when the information processing units 11A and 11B of the respective segments 1 and 2 execute path calculation. Further, as stated above, the external WAN server 14 is configured to have a function of receiving setting completion notices from the respective OpenFlow switches 31 and instructing start of communication.

To be specific, as shown in FIG. 7, the external WAN server 14 includes a DNS function part 81, a topology information DB (database) 82, a flow table information DB 83, a policy information DB 84, and a communication management function part 65.

The DNS function part 81 is a part which executes address resolution across segments at the time of communication across segments. Address resolution will be described later. The communication management function part 85 is a part which receives setting completion notices from the respective OpenFlow switches 31 to which the information processing unit 11A has transmitted flow entries because transfer setting is required as described above. Then, the communication management function part 85 is a part which, upon receiving setting completion notices from all the OpenFlow switches that are the target of transfer, sends a communication start instruction to the administrator function part 42 included by the information processing unit within the segment which is the source of communication. Further, information about the networks of the respective segments collected by the administrator function parts in the respective segments is aggregated in each of the databases.

Below, the respective databases will be described in detail. Each of the databases, which are the topology information DB 72, the flow table information DB 83 and the policy information DB 84, is made up by a storage device such as a memory or a hard disk. The topology information DB 82 is a database which stores topology information. Topology information is information of a network connection form, such as what switch connects to what port of an OpenFlow switch located in each segment. The flow table information DB 83 is a database which stores a flow table used at the time of processing information received by an OpenFlow switch within each segment described above. The policy information DB 84 is a database which stores a security policy in each segment such as access priority. As stated above, the information processing unit 11A calculates a path across a plurality of segments by using the information stored in the respective databases. In this exemplary embodiment, the external WAN server 14 is configured by a single device. However, in the present invention, the external WAN server 14 does not need to be always realized by a single device. For example, the function of the external WAN server 14 may be realized by a plurality of devices which are distributed on the cloud.

Further, an external storage device may be connected to the external WAN server 14 via a communication line which allows mutual communication. The external storage device includes a DNS DB, a topology information DB, a flow table DB, and a policy information DB. Every time information about DNS stored in the external WAN server 14 connected to the external storage device, topology information, flow table information, or policy information is updated, the external storage device replicates and stores the information. Connection of the external storage device replicating and storing information of the external WAN server 14 makes it possible to, for example, even if any trouble occurs in the external WAN server 14, handle without any problem.

The detailed configuration of the communication system in the first exemplary embodiment has been described above. In this exemplary embodiment, the function of the OpenFlow controller is realized by the information processing units 11A and 11B, or a plurality of information processing units distributed on the cloud. However, it is not always necessary to realize the function of the OpenFlow controller on the cloud. Moreover, the external WAN server 14 does not need to be always placed on the cloud, which is different from the segments 1 and 2.

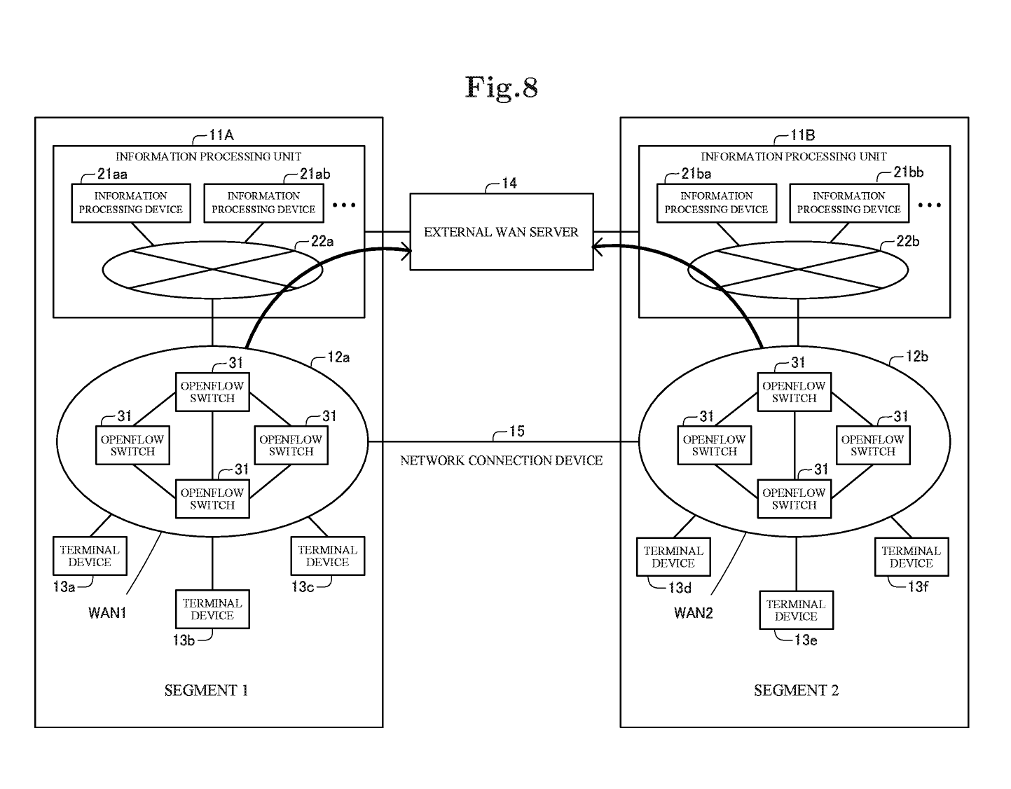

Next, referring to FIGS. 8 to 14, the operation of the communication system in this exemplary embodiment when there is a need to transmit information from the terminal device 13a in the segment 1 to the terminal device 13e in the segment 2 will be described. In this exemplary embodiment, information is transmitted from the terminal device 13a. Therefore, the information processing unit 11A located in the segment 1 in which the terminal device 13a as an information transmission source is located serves as a higher-level communication path instruction device (a higher-level communication path instruction unit) which instructs establishment of a communication path passing through a plurality of networks by using the information aggregated by the information aggregation unit.

Let us suppose, in this exemplary embodiment, it is an assumption in operation to be described later that information of the respective networks 12a and 12b within the segments 1 and 2 is aggregated and stored by the external WAN server 14 as shown in FIG. 8. To be specific, the administrator function parts 42 included by the information processing units 11A and 11B in the segments 1 and 2 monitor the networks 12a and 12b controlled by the respective administrator function parts 42 and, every time there is a change in the network 12a or 12b, transmit the information to the external WAN server 14. As mentioned above, information aggregated in this exemplary embodiment is topology information configured by connection information or the like of the respective OpenFlow switches, flow table information used when the OpenFlow switches in the respective segments transfer information, and policy information which is a security policy of each of the segments.

### (Operation)

First, upon starting communication, the terminal device 13a transfers communication source information (e.g., the IP address, MAC address, and the like, of the terminal device) and communication destination information (e.g., telephone number, e-mail address, URL, and the like) to the OpenFlow switch 31 within the network 12a.

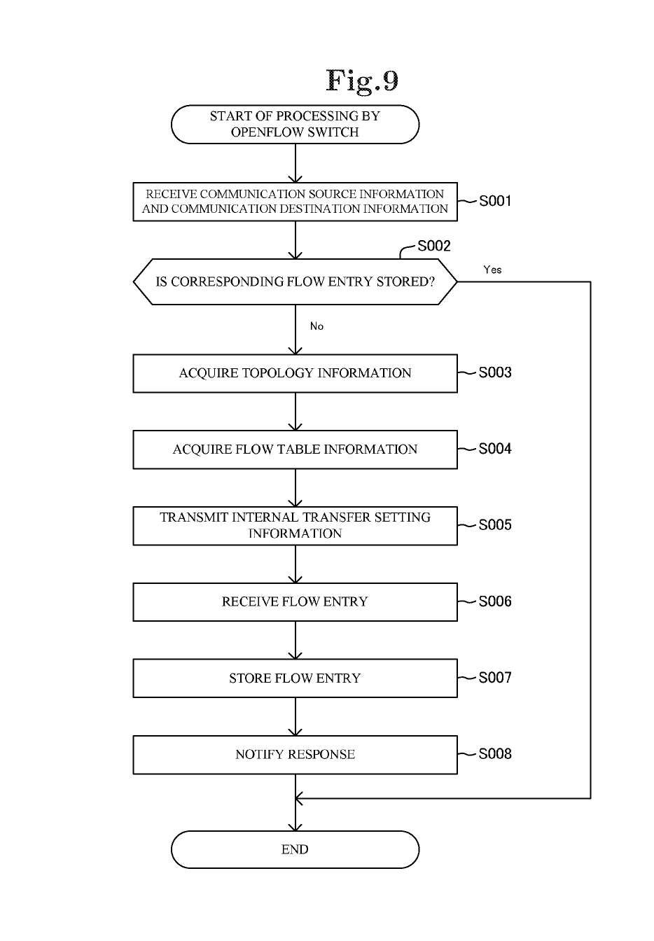

As shown in FIG. 9, upon receiving the communication source information and the communication destination information (step S001), the transfer control part 71 (see FIG. 5) of the OpenFlow switch 31 determines whether a related flow entry is recorded on the flow table DB 72 (step S002). Then, in a case where a related flow entry is recorded in the flow table DB 72, the OpenFlow switch 31 controls communication in accordance with the flow entry. On the other hand, in a case where a related flow entry is not recorded, the OpenFlow switch 31 inquires to the information processing unit 11A how to handle. To be specific, the transfer control part 71 acquires topology information (information showing the connection state of another OpenFlow switch or the like connected to the respective ports of the OpenFlow switch), and flow entry information (information of flow entries stored in the OpenFlow switch) (steps S003 and S004), and transmits internal transfer setting information composed of the topology information and flow entry information mentioned above, the communication source information, and the communication destination information to the administrator function part 42 included by the information processing unit 11A (step S005). After that, the OpenFlow switch receives and stores a flow entry transmitted after a process to be described later (steps S006 and S007). Then, the OpenFlow switch notifies completion of setting (step S008).

Meanwhile, upon acquiring the respective information described above, the administrator function part 42 figures out from the acquired information that communication of transmission from the terminal device 13a to the terminal device 13e is communication across the segments. Then, the administrator function part 42 executes address resolution and network resolution (path calculation), which will be described later, while transferring the abovementioned information to the external WAN server 14. Performing address resolution and network resolution (path calculation) makes it possible to perform communication from the terminal device 13a to the terminal device 13e via the segments.

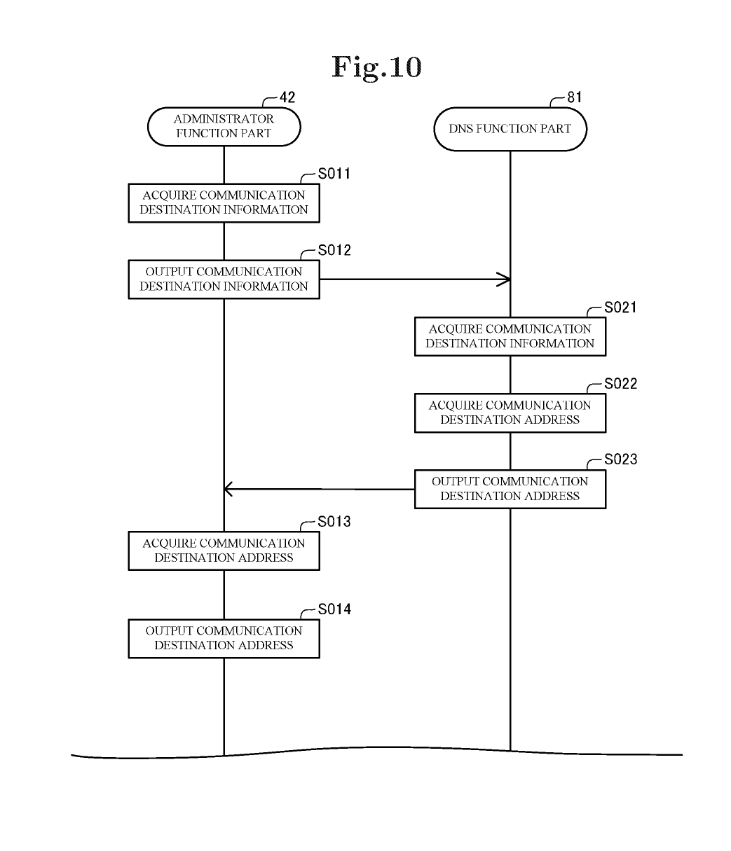

First, referring to FIG. 10, address resolution will be described. As mentioned above, upon acquiring the information including the communication destination information (step S011), the administrator function part 42 figures out that the communication is communication passing through the segments. Then, the administrator function part 42 outputs the communication destination information to the DNS function part 81 within the external WAN server 14 (step S012). Upon receiving the communication destination information (step S021), the DNS function part 81 acquires a communication destination address (e.g., an IP address) stored in the DNS function part 81 in association with the received communication destination information (step S022). Then, the DNS function part 81 outputs the acquired communication destination address to the administrator function part 42 (step S023). After that, upon acquiring the communication destination address from the DNS function part 81 within the external WAN server 14 (step S013), the administrator function part 42 outputs the communication destination address to the terminal device 13 via the virtual machine control function part 41 (step S014). Through the operation described above, the terminal device 13 can acquire a communication destination address, which is address information of a communication destination device. In this exemplary embodiment, the communication destination terminal device 13e belongs to the segment 2, which is different from the segment 1 to which the communication source terminal device 13 belongs. That is to say, it is thought that a proper communication destination address corresponding to communication destination information is not recorded in the DNS function part 44 included by the information processing unit 11A within the segment 1. Therefore, the administrator function part 42 instructs execution of address resolution using information in the DNS database 81 of the external WAN server 14. However, exemplary embodiments of the present invention are not limited to the case of performing the abovementioned operation. The present invention can be practiced by, for example, using the DNS function part 44 within the information processing unit 11A and, when necessary, referring to information within the external WAN server 14.

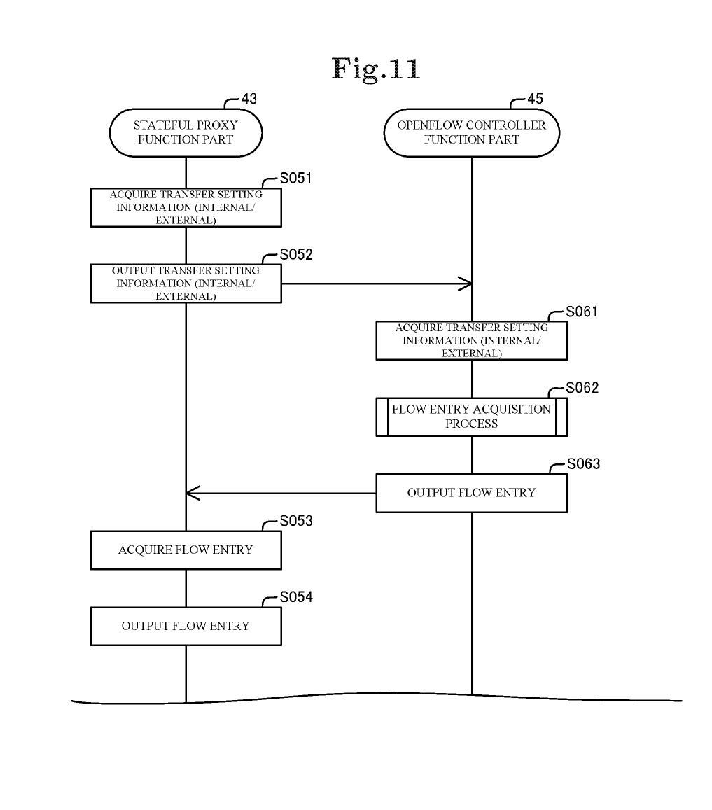

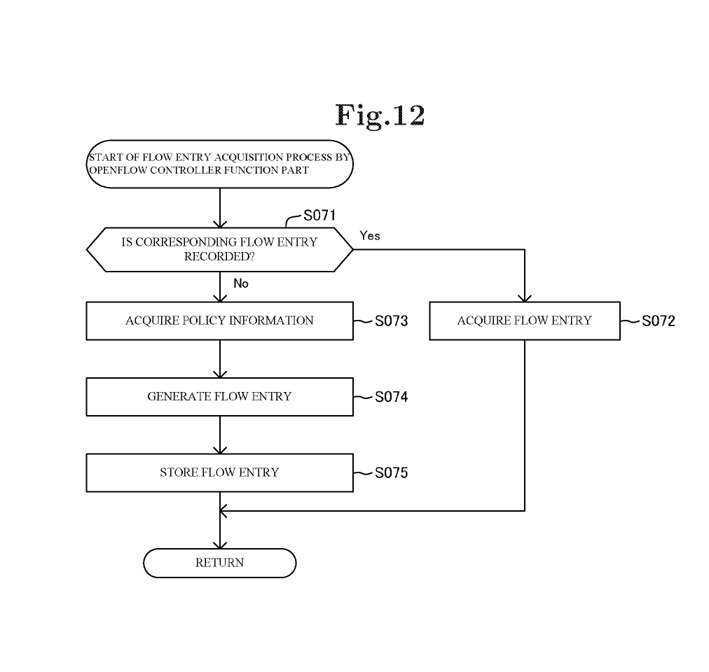

Next, referring to FIG. 11, network resolution will be described. Network resolution may be executed in parallel with address resolution shown in FIG. 10.

In this exemplary embodiment, communication passing through segments is performed as stated above. Therefore, for execution of network resolution to be described later, not only internal transfer setting information of the inside of the segment 1 but also external transfer setting information such as topology information of the inside of the segment 2 is required. Then, the administrator function part 42 sends a signal to the external WAN server 14 so that the external WAN server 14 transmits necessary external transfer setting information such as topology information. Upon receiving the signal, the external WAN server 14 transmits external transfer setting information to the administrator function part 42. The external transfer setting information is composed of topology information, flow table information and policy information of the inside of the segment 2, which are respectively recorded on the topology information DB 82, the flow table information DB 83 and the policy information DB 84 included by the external WAN server 14. Through the operation described above, the administrator function part 42 acquires transfer setting information (internal/external) including: the internal transfer setting information composed of the topology information and flow table information of the inside of the segment 1; the external transfer setting information composed of the topology information, flow table information and policy information of the inside of the segment 2; the communication destination information; and the communication source information. The succeeding operation will be described with FIG. 11.

As stated above, the administrator function part 42 acquires the transfer setting information (internal/external). Then, the administrator function part 42 outputs the transfer setting information (internal/external) to the OpenFlow controller function part 45 via the stateful proxy function part 43 (steps S051 and S052). Next, upon acquiring the transfer setting information (internal/external) from the stateful proxy function part 43 through the operation described above (step S061), the OpenFlow controller function part 45 executes a flow entry acquisition process for acquiring a flow entry to be described later, by using the transfer setting information (internal/external) (step S062). Then, the OpenFlow controller function part 45 outputs the flow entry acquired through the operation described above to the stateful proxy function part 43 (step S063). After that, upon acquiring the flow entry, the stateful proxy function part 43 outputs the flow entry to the respective OpenFlow switches via the administrator function part 42 (steps S053 and S054). Through the operation described above, the administrator function part 42 executes network resolution.

Next, referring to FIG. 12, the flow entry acquisition process will be described.

As shown in FIG. 12, the OpenFlow controller function part 45 first determines whether or not a related flow entry is recorded (step S071). That is to say, the OpenFlow controller function part 45 determines whether or not information based on at least one of the communication source information and the communication destination information within the transfer setting information (internal/external) acquired in processing at step S061 of FIG. 12 is included in “conditions” of flow entries recorded in the flow table server function part 47 or “conditions” of flow entries within flow table information of the segment 2 acquired from the external WAN server 14.

In the case of determining that a related flow entry is stored (step S071: Yes), the OpenFlow controller function part 45 acquires a flow entry stored in the flow table server function part 47 or a flow entry stored in the flow table information of the segment 2 acquired from the external WAN server 14 (step S072), and outputs the flow entry to the stateful proxy function part 43.

On the other hand, in the case of determining that a related flow entry is not stored (step S071: No), the OpenFlow controller function part 45 acquires policy information recorded in the policy server function part 46 (step S073). Then, the OpenFlow controller function part 45 generates a flow entry on the basis of: the topology information and flow table information of the segment 1 and the topology information, flow table information and policy information of the segment 2, which are included by the transfer setting information (internal/external); and the policy information of the segment 1 acquired through the abovementioned operation (step S074). That is to say, the OpenFlow controller function part 45 sets a path between the communication source device and the communication destination device on the basis of the transfer setting information (internal/external) and the policy information of the segment 1, and sets the “condition” for transferring packet information through the set path and the “content of processing.”

Then, the OpenFlow controller function part 45 stores the generated flow entry and also outputs the flow entry to the stateful proxy function part 43 (step S075).

Upon acquiring the flow entry generated by the OpenFlow controller function part 45 in the abovementioned method, the stateful proxy function part 43 outputs the flow entry to the OpenFlow switches 31 via the virtual machine control function part 41 (see step S054 in FIG. 11).

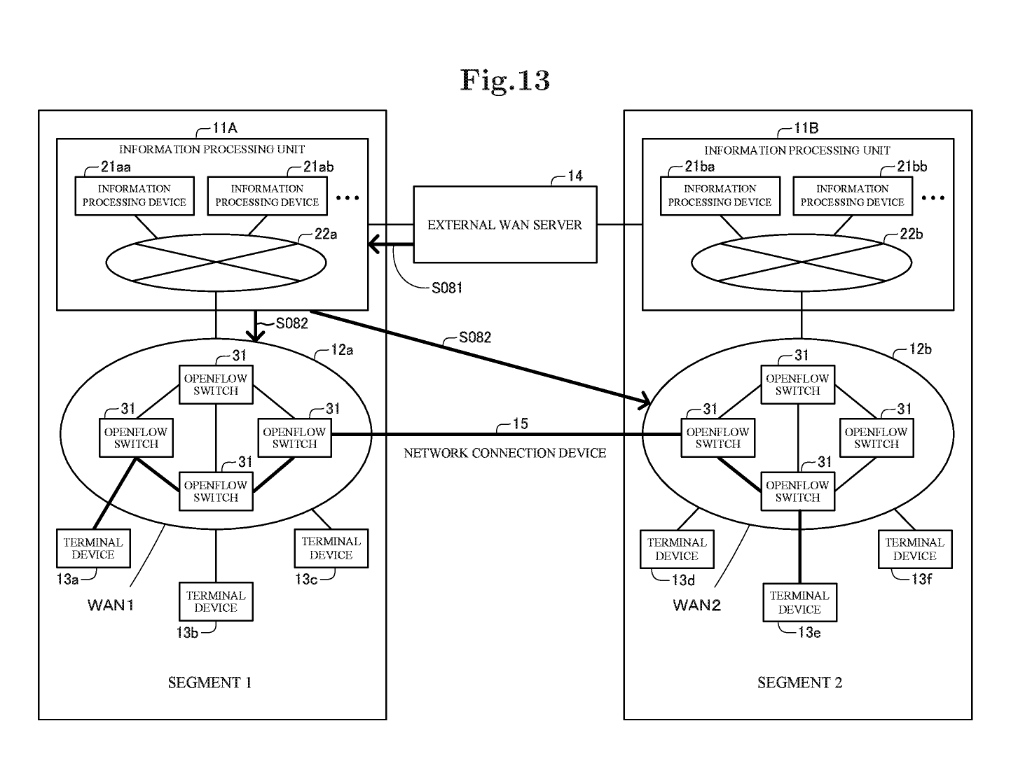

As stated above, the information processing unit 11A refers to the information stored in the external WAN server 14 (step S081 in FIG. 13), and the information processing unit 11A can thereby execute network resolution for the OpenFlow switches 31 in the networks of the respective segments (step S082) (see FIG. 13). That is to say, setting a path leading from the terminal device 13a to the terminal device 13e and setting the “condition” for transferring packet information through the set path and the “content of processing” allows the terminal device 13a and the terminal device 13e shown in FIG. 13 to perform communication (e.g., perform communication through a thick line connecting the terminal devices 13a and 13e in FIG. 13).

The succeeding flow is as stated for the configuration of the OpenFlow switch 31. That is to say, upon receiving the flow entry, each of the OpenFlow switches 31 sets the flow entry in the flow table (transfer setting). Then, when transfer setting is complete, the OpenFlow switches 31 each transmit a setting completion notice to the external WAN server 41 via the administrator function part 42 within the information processing unit 11A. After that, upon receiving setting completion notices from all the OpenFlow switches that are the target of setting, the external WAN server 14 makes a communication start instruction to a terminal which is to perform communication and the OpenFlow switch 31 to be used in communication, via the administrator function part 42 within the information processing unit 11A. This activity allows the OpenFlow switch 31 to be used in communication to properly process packets transmitted in the communication.

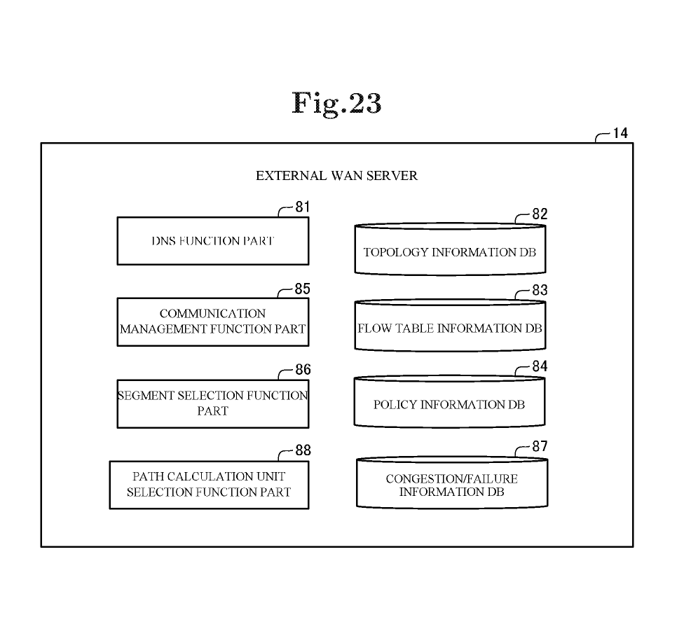

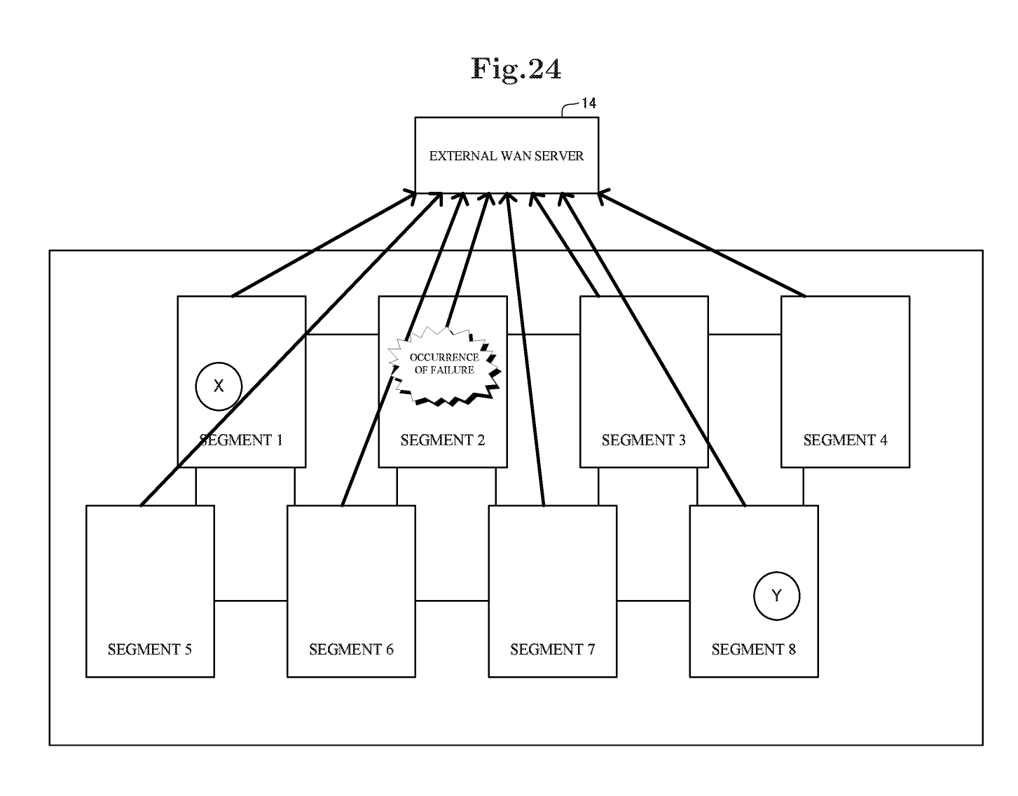

As stated above, not only the topology information and policy information of the segment 2 but also the topology information and so on of the segment 1 is previously stored in the external WAN server 14. Therefore, according to the present invention, it is possible to execute network resolution by using the network topology information, flow table information, policy information and so on of the segment 1 and the segment 2, stored in the external WAN server 14, without acquiring internal transfer setting information such as the topology information from the OpenFlow switch 31 within the segment 1. Further, in this exemplary embodiment, the information processing unit 11A within the segment 1 to which the terminal device 13a having started communication belongs performs path calculation (the information processing unit 11A in the segment 1 serves as the higher-level information processing unit). However, for example, by providing the external WAN server 14 with a path calculation unit selection function part 88 shown in FIG. 23 to be described later, it is possible to cause an information processing unit in a segment (the segment 2 in this exemplary embodiment) other than the segment 1 to execute path calculation (the role of the higher-level communication path instruction unit may be taken by an information processing unit in a segment other than the segment 1). Further, by using information aggregated by the external WAN server 14 to perform path calculation, it is possible to cause the information processing unit 11A within the segment 1 and the information processing unit 11B within the segment 2 to execute path calculation, respectively (the role of the higher-level communication path instruction unit may be distributed to and taken by a plurality of information processing units). Because information necessary for path calculation is gathered by the external WAN server 14, use of the information enables execution of path calculation. Further, the communication system in this exemplary embodiment may include an information processing unit (a higher-level information processing unit) which uses information aggregated by the external WAN server 14 and instructs establishment of a communication path passing through a plurality of networks, separately from the information processing unit 11A in the segment 1 and the information processing unit 11B in the segment 2.

By the method described above, it is possible to execute path calculation with respect to a network of a different segment.

### Second Exemplary Embodiment

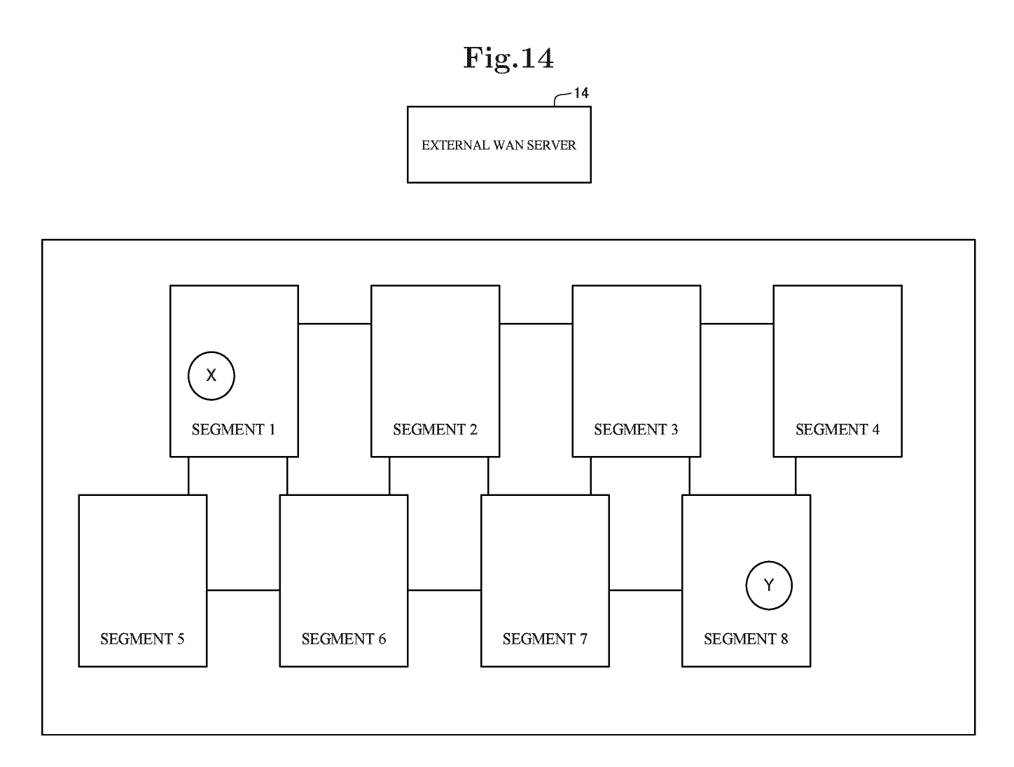

Next, a communication system according to a second exemplary embodiment of the present invention will be described referring to FIGS. 14 to 21. The communication system according to the second exemplary embodiment is a communication system in which the number of the segments described in the first exemplary embodiment is plural. That is to say, the second exemplary embodiment describes a case where it is required to establish a communication path through a plurality of segments. As shown in FIG. 14, this exemplary embodiment shows a case where the number of the segments is eight. However, the present invention can be practiced independent of the number of the segments.

### (Configuration)

The structure inside a single segment is the same as the structure described in the first exemplary embodiment. In other words, a single segment is configured by the information processing unit 11, the network 12 connecting the OpenFlow switches 31, and the terminal devices connecting to the network. The respective components are configured in the same manner as in the first exemplary embodiment.

In this exemplary embodiment, as shown in FIG. 14, the network 12 within the segment 1 is connected to the networks 12 within the segments 2, 5 and 6 by an internetworking device. Moreover, the network 12 within the segment 2 is connected to the networks 12 within the segments 3, 6 and 7 in addition to the network 12 within the segment 1, and the network 12 within the segment 3 is connected to the networks within the segments 4, 7 and 8 in addition to the network within the segment 2. Likewise, the network 12 within the segment 4 is connected to the network within the segment 8 in addition to the network 12 within the segment 3, and the network 12 within the segment 5 is connected to the network 12 within the segment 6 in addition to the network 12 within the segment 1. Moreover, the network 12 within the segment 6 is connected to the network 12 within the segment 7 in addition to the networks 12 within the segments 1, 2 and 5, and the network 12 within the segment 7 is connected to the network 12 within the segment 8 in addition to the networks 12 within the segment 2, 3 and 6. This exemplary embodiment shows a case where the respective networks are connected in the abovementioned manner. However, connection of the segments is not limited to the case shown by this exemplary embodiment. For example, the segment 1 may be connected to only the segment 2 and 6 and not connected to the segment 5. The present invention can be practiced independent of how to connect the segments.

As in the first exemplary embodiment, the external WAN server 14 aggregates information collected by the administrator function parts of the information processing units 11 within the respective segments. That is to say, in the external WAL server 14, the topology information, flow table information and policy information of the networks within the segments 1, 2, 3, 4, 5, 6, 7 and 8 are aggregated.

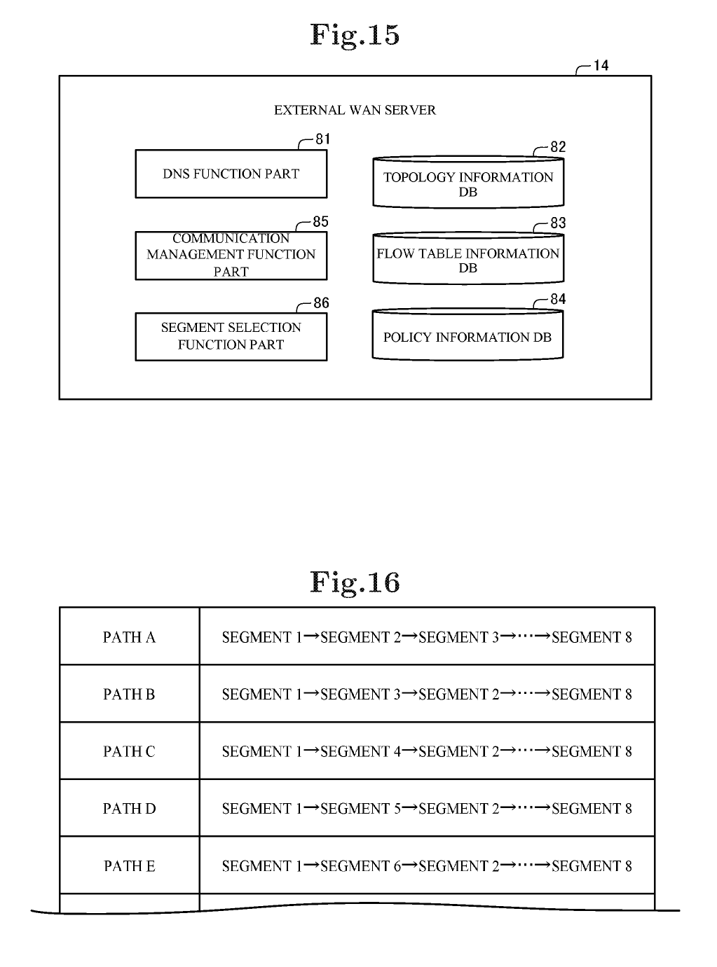

The external WAN server 14 in the second exemplary embodiment has not only the function of aggregating information of the respective segments but also a function of using the aggregated information of the respective segments and determining segments (a segment sequence) to be subjected to address resolution and network resolution. Thus, as shown in FIG. 15, the external WAN server 14 in the second exemplary embodiment includes, in addition to the components shown in the first exemplary embodiment (see FIG. 7), a segment selection function part 86 (a segment selection unit) which selects segments (networks within segments) to be used for path calculation (address resolution, network resolution).

As stated above, the segment selection function part 86 selects a segment sequence to be subjected to path calculation, by using information of the respective segments aggregated by the external WAN server 14. To be specific, as shown in FIG. 16, the external WAN server 14 lists all the combinations of the segments 1 to 8 and then eliminates duplicated ones. Next, by using the topology information gathered by the administrator function parts of the respective segments described above, the segment selection function part 86 deletes a path including segments arranged without a contiguous point between the networks. For example, a path B shown in FIG. 16 includes a sequence “segment 1→segment 3” in which the networks within the respective segments are not connected. Likewise, a path C includes a sequence “segment 1→segment 4” in which the networks are not connected, and a path D includes a sequence “segment 5→segment 2” in which the networks are not connected (see FIG. 14). The segment selection function part 86 deletes such paths including a sequence without a contiguous point by using the topology information recorded in the external WAN server 14. Then, the segment selection function part 86 selects networks to be subjected to path calculation in a manner that the number of the connection points of the networks is smaller. In this exemplary embodiment, segments to be subjected to path calculation are selected in a manner that the number of the connection points of the networks is smaller, but selection of the segments is not limited to the abovementioned method. For example, use of flow table information in addition to topology information enables estimation of the distribution amount of information within a segment relating to the flow table information from the number of flow entries in the flow table information. On the basis of information of the estimated distribution amount, segments may be selected in a manner that the amount of distributed information becomes smaller (assumed to be far from the congestion state).

Here, it can be conceived that the segment selection function part 86 narrows segment sequences to be used for path calculation to one. On the other hand, in a case where a plurality of segment sequences have an identical number of connection points, the segment selection function part 86 may narrow them to plural, for example, about ten, and then select networks to be subjected to path calculation. The segment selection function part 86 may realize its function as one function within the external WAN server 14 as shown in this exemplary embodiment, or may realize its function with an additionally provided device which is independent of the external WAN server 14, for example.

The operation after segments to be used for path calculation are selected by the segment selection function part 86 as described above is the same as in the first exemplary embodiment. That is to say, an information processing unit within a segment which is the transmission source of communication through the segments calculates a communication path passing through the segments selected by the segment selection function part 86 by using the information aggregated by the external WAN server 14. To be specific, for example, to perform communication from X within the segment 1 to Y within the segment 8 as shown in FIG. 14, the information processing unit 11A within the segment 1 executes communication path calculation on one segment sequence or a plurality of (e.g., ten) segment sequences selected by the segment selection function part 86.

Further, the information processing unit in each of the segments includes a communication path determination unit, which is not shown in the drawings. As stated above, the information processing unit within the segment 1 executes communication path calculation on one segment sequence or a plurality of (e.g., ten) segment sequences selected by the segment selection function unit 86. Therefore, in a case where a plurality of segment sequences are selected by the segment selection function part 86, path calculation is executed plural times. Then, the information processing unit having executed path calculation on a plurality of segment sequences as mentioned above needs to determine a segment sequence actually used in communication from among the segment sequences having been subjected to the path calculation. A means used in the determination is the communication path determination unit. For example, in a case where the segment selection function part 86 narrows segment sequences to be subjected to path calculation to ten, the information processing unit within the segment 1 executes path calculation on the ten segments. In this case, ten path calculation results are obtained. Therefore, the information processing unit within the segment 1 needs to determine one communication path to be actually used in communication from among the ten segment sequences having been subjected to path calculation. Thus, one path to be actually used in communication is determined by using the communication path determination unit.

The communication path determination unit determines a communication path to be used in communication by, for example, comparing flow tables. To be specific, for example, when the segment selection function unit 86 narrows network sequences to ten, the information processing unit within the segment 1 executes path calculation on the ten network sequences. Then, the communication path determination unit compares the results of path calculation and determines, as a communication path to be used in communication, a path passing through switches having less flow tables, namely, a path connected by switches whose communication traffic is supposed to be the least. Meanwhile, determination of a communication path according to the present invention is not limited to using the abovementioned means.

In this exemplary embodiment, the information processing unit in each of the segments includes the communication path determination unit. With this configuration, regardless of which information processing unit executes path calculation, the information processing unit executing path calculation includes the communication path determination unit. Therefore, it is possible to determine a communication path by using the communication path determination unit within the information processing unit having executed path calculation. However, the information processing units in the respective segments do not need to all include the communication path determination units. For example, the communication path determination unit may be included by the external WAN server 14. In this case, after execution of path calculation on a plurality of segment sequences, determination of a communication path is asked to the external WAN server again. Alternatively, an external device which is independent of the external WAN server may have the function.

Next, the operation of the communication system in the second exemplary embodiment will be described.

### (Operation)

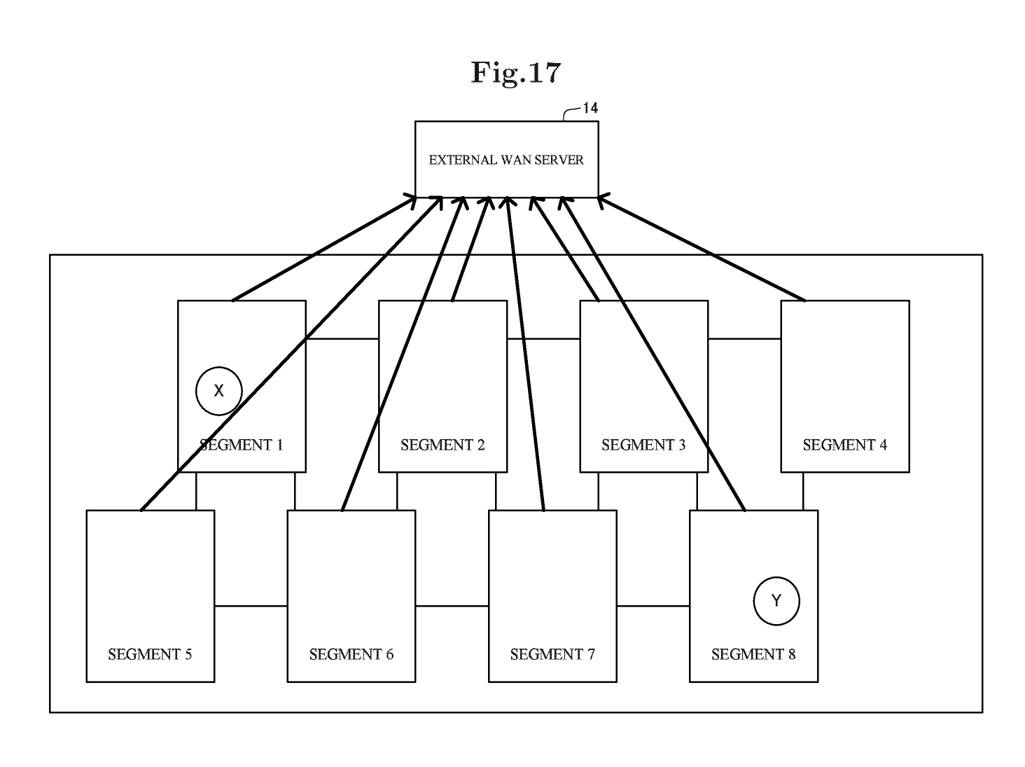

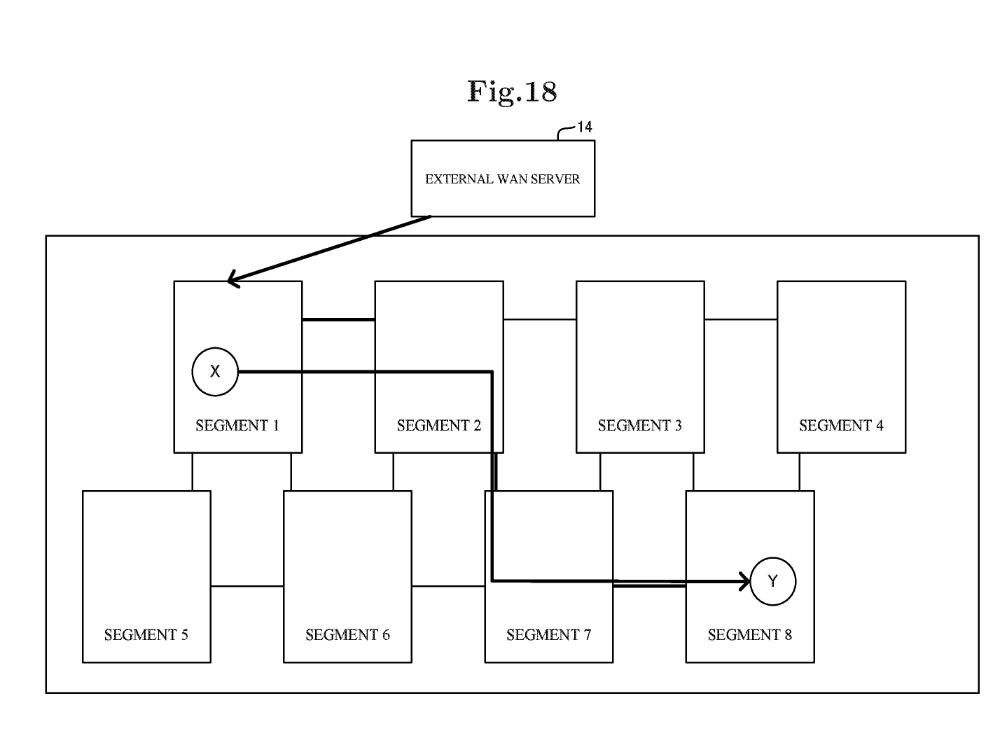

First, in the operation of the communication system according to the second exemplary embodiment, when it is required to calculate a communication path passing through a plurality of segments, the topology information, flow table information and policy information of segments which are potentially used for the communication path are aggregated and stored into the external WAN server 14 by the administrator function parts in the respective segments as shown by arrows in FIG. 17.

Next, the external WAN server 14 (the segment selection function part 86 therein) lists sequences of the segments whose information has been aggregated (see FIG. 16). The external WAN server 14 eliminates a sequence including segments arranged without a contiguous point from among the listed segment sequences by using the topology information aggregated in the external WAN server 14. Then, the external WAN server 14 selects a path in which the number of connection points is smaller from among sequences of segments contiguous with each other. The path may be selected by narrowing to one if segments passed through are not so many. On the other hand, it is also possible to use a method such as narrowing segments used for path calculation to some degree, for example, selecting about ten paths with less connection points.

Let us suppose, in the case shown in FIG. 14, the external WAN server 14 (the segment selection function part 86 therein) selects a sequence of the segments 1, 2, 7, 8 or a sequence of segments 1, 2, 3, 8 from among a plurality of segment sequences. The sequence of the segments 1, 2, 7, 8 and the sequence of segments 1, 2, 3, 8 are sequences of segments having mutual connection points and less connection points. Then, the external WAN server 14 gives an instruction to calculate a communication path passing through the segments 1, 2, 7, 8 and a communication path passing through the segments 1, 2, 3, 8 to the information processing unit within the segment 1 to which X as the transmission source of communication belongs, as shown in FIG. 18. Upon receiving the instruction, the information processing unit within the segment 1 executes path calculation on the respective sequences by using information stored in the external WAN server 14 storing information of the networks within the segments 1, 2, 3, 7 and 8 as shown in the first exemplary embodiment.

Next, the communication path determination unit within the information processing unit having executed the path calculation (the information processing unit within the segment 1) determines a communication path to be actually used in communication. Let us suppose, in the case shown in FIG. 18, a path passing through switches with less flow tables, namely, a path connected by switches whose communication traffic is supposed to be the least is the sequence of the segments 1, 2, 7, 8, for example. Then, as shown in FIG. 18, the communication path determination unit within the information processing unit having executed the path calculation (the information processing unit within the segment 1) determines use of the sequence of the segments 1, 2, 7, 8 as a communication path, and transmits a corresponding flow entry to the OpenFlow switches within the networks within the segments 1, 2, 7 and 8. Through the operation described above, network resolution is executed, and communication from X within the segment 1 to Y within the segment 8 is allowed. The following operation is the same as in the first exemplary embodiment.

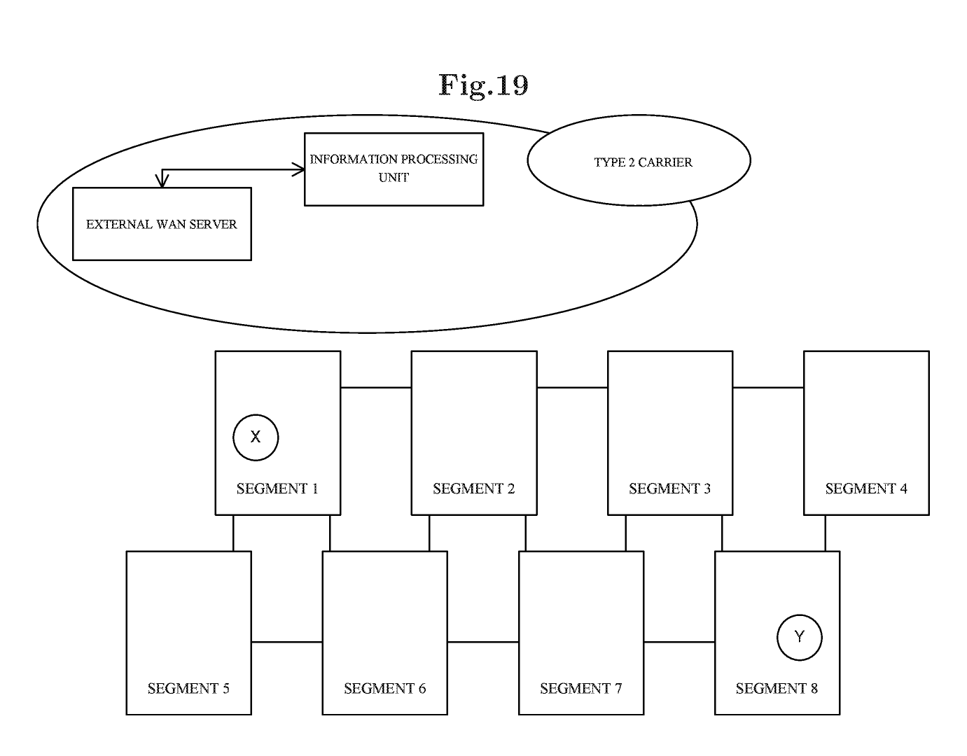

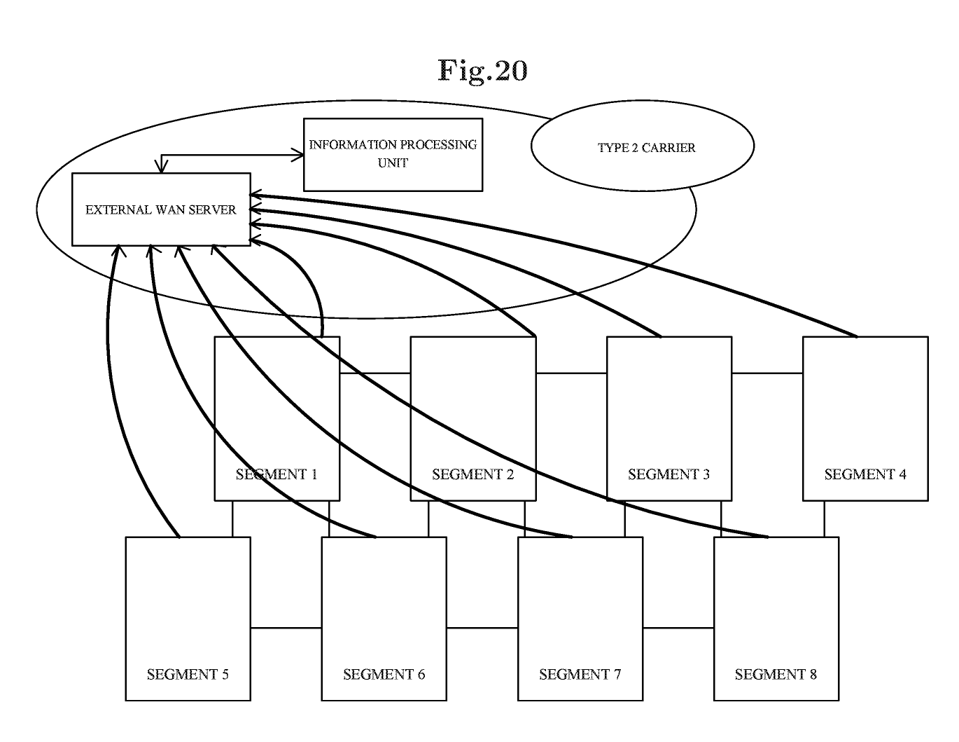

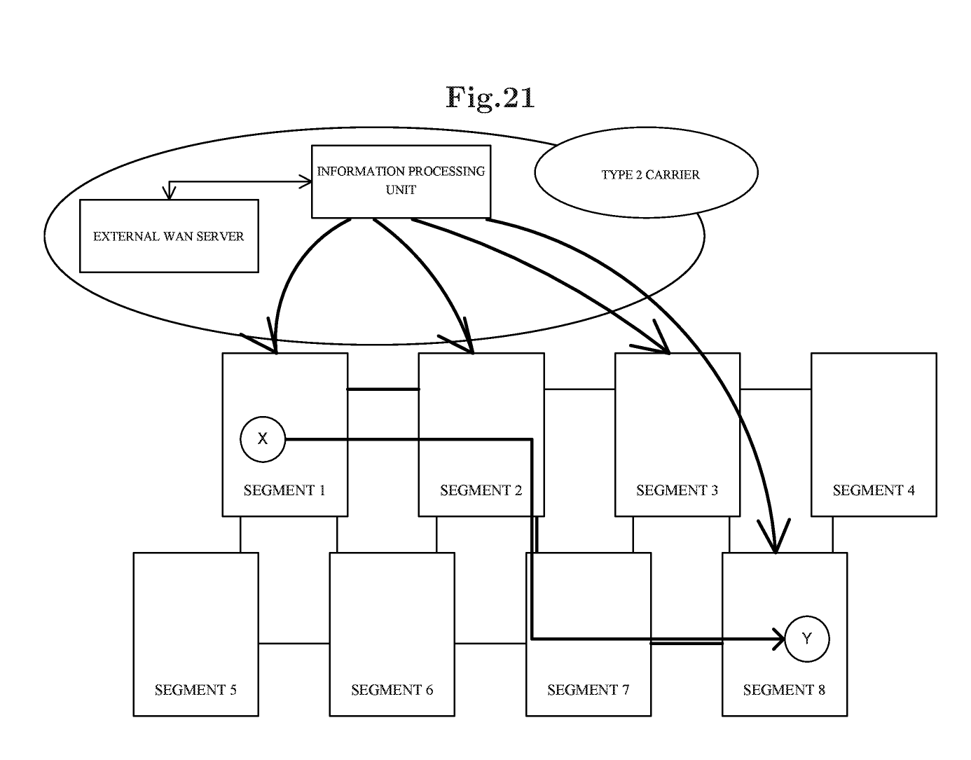

Meanwhile, as shown in FIG. 19, in this exemplary embodiment, the external WAN server 14 and an information processing unit (an OpenFlow controller) which executes path calculation by using information aggregated in the external WAN server 14 may be provided independent of each segment. For example, providing the abovementioned functions outside the segments makes it possible to cover path calculation of the segments (e.g., use by a type 2 carrier is expected). The operation in this case is also the same as stated above. First, as shown in FIG. 20, the external WAN server aggregates information from segments which are potentially used for a communication path. Then, the external WAN server selects segments to be used for path calculation and, as shown in FIG. 21, an open flow controller included by a type 2 carrier executes address resolution and network resolution by using information stored in the external WAN server 14 storing information of the networks within the segments 1, 2, 7 and 8.

The operation described above makes it possible to calculate a path passing through a plurality of segments.

### Third Exemplary Embodiment

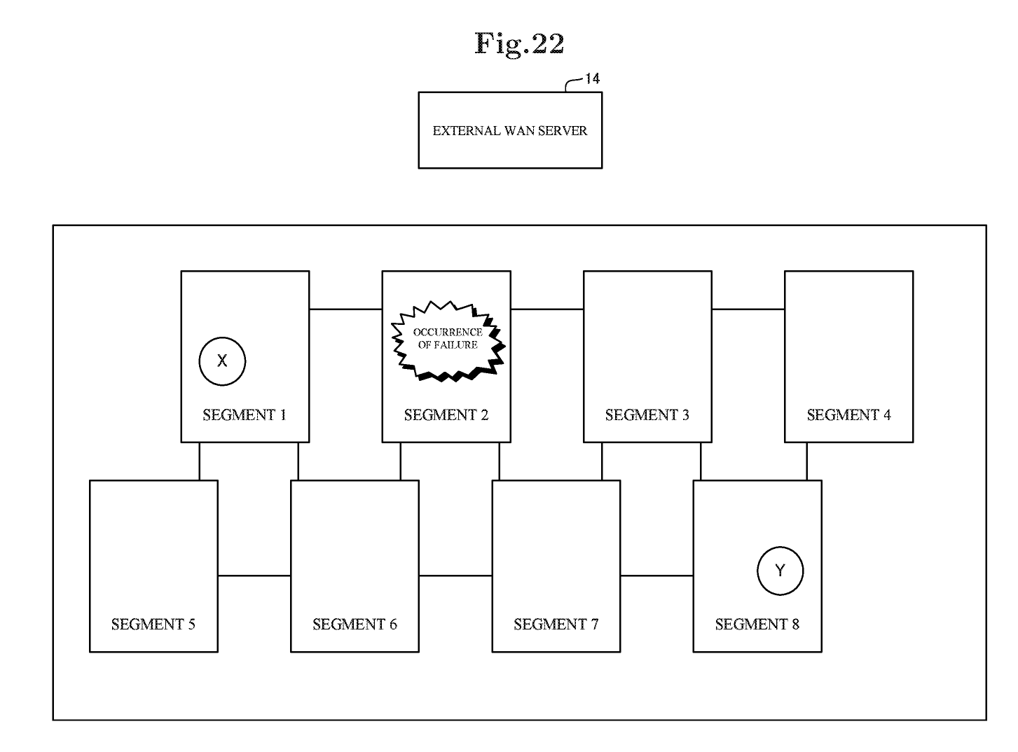

Next, a communication system according to a third exemplary embodiment of the present invention will be described referring to FIGS. 22 to 25. The communication system according to the third exemplary embodiment includes the same configuration as in the case where there are a plurality of segments as described in the second exemplary embodiment. That is to say, the communication system includes a plurality of segments and the external WAN server 14.

The third exemplary embodiment shows a case of occurrence of failure or congestion in the network within a certain segment which is potentially used for path calculation. In this exemplary embodiment, a case where failure has occurred in the segment 2 as shown in FIG. 22 will be described. However, the present invention can be practiced without any problem even if congestion/failure occurs in a segment other than the segment 2. The present invention does not rely on which segment congestion/failure occurs in. Moreover, the present invention can be practiced also in a situation where congestion/failure is occurring in a plurality of segments.

### (Configuration)

The inner structure of a single segment is the same as the structure described in the first exemplary embodiment. That is to say, a single segment is configured by the information processing unit 11, the network 12 connecting the OpenFlow switches 31, and the terminal devices 13 connected to the network. Further, the network within each segment is connected to at least one network within another segment. The external WAN server 14 has the same configuration as in the second exemplary embodiment.

In the third exemplary embodiment, the administrator function part 42 within each segment has a function of observing whether or not failure is occurring in the network controlled by the administrator function part 42, whether or not the network controlled by the administrator function part 42 is in the congestion state, and the like. Then, in a case where failure or congestion is occurring in the network controlled by the administrator function part 42, the administrator function part 42 transmits congestion/failure information on congestion/failure within the segment together with various kinds of network information such as topology information, to the external WAN server 14. By using the congestion/failure information transmitted to the external WAN server 14, the external WAN server 14 selects segments to be used for path calculation so as to avoid the segment including the network in the failure or congestion state.

Further, in this exemplary embodiment, the administrator function part 42 within each segment may additionally include a congestion/failure state resolution instruction function which, when the administrator function part 42 transmits the acquired congestion/failure information to the external WAN server 14, gives a congestion/failure state resolution instruction to the information processing unit 11 having acquired the congestion/failure information so that the congestion/failure state is resolved. To be specific, the administrator function part 42 specifies an information processing device 21 taking a function likely to cause congestion or failure from among the information processing devices 21, which have functions such as the OpenFlow controller function part 45, the policy server function part 46 and the flow table server function part 47, included by the information processing unit 11. Then, the administrator function part 42 gives an instruction to increase the specified information processing device 21 (having the function likely to cause congestion/failure) among the information processing devices 21 included by the information processing unit 11. In response to the instruction, the information processing device 21 having the function likely to cause congestion/failure is increased. Such a configuration makes it possible to put more information processing devices 21 in charge of processing of the function likely to cause congestion or failure. Consequently, the congestion/failure state can be prevented from occurring or from worsening. Meanwhile, in a case where another information processing unit exists in the same segment, the administrator function part 42 in the congestion/failure state instructs the other information processing unit to execute processing. Further, an instruction to resolve the congestion/failure state can be made at given timing independent of communication processing in the present invention.

Next, the configuration of the external WAN server 14 in the third exemplary embodiment will be described. The external WAN server 14 in the third exemplary embodiment includes a congestion/failure information DB 87 in addition to the DNS function part 81, the topology information DB 82, the flow table information DB 83, the policy information DB 84, the communication management function part 85 and the segment selection function part 86 as shown in FIG. 23. The congestion/failure information DB 87 is a database which stores congestion/failure information. Therefore, congestion/failure information transmitted from the administrator function part 42 within each segment is stored into the congestion/failure information DB 87. Further, the segment selection function part 86 in this exemplary embodiment selects segments to be used for path calculation on the basis of the topology information, flow table information, policy information and congestion/failure information acquired and stored. The external WAN server 14 may include a path calculation unit selection function part 88 (a higher-level path instruction device selection unit) which selects an information processing unit executing path calculation by using the congestion/failure information.

When the administrator function part 42 within each segment acquires congestion/failure information, the external WAN server 14 can select segments to be used for path calculation so as to avoid a segment in which failure is occurring and a segment in which the network is in the congestion state. As information for selecting segments, it is possible to use flow table information in addition to the abovementioned congestion/failure information, for example. To be specific, the amount of flow entries recorded on the flow table DB is used as an index of the data traffic currently flowing in the network. Consequently, it is possible to select networks (segments having them) in which data traffic is considered to be less.

Further, as stated above, the external WAN server 14 may include the path calculation unit selection function part 88 (the higher-level path instruction device selection unit). The path calculation unit selection function part 88 is configured by an information processing unit selection part and a path calculation instruction part, which are not shown in the drawings, and performs selection of an information processing unit to be used for path calculation. Selection of an information processing unit to be used in path calculation is performed by, for example, using congestion/failure information aggregated in the external WAN server 14. To be specific, let us suppose the segment 1 as the transmission source of communication is about to fall into the congestion state. If the information processing unit within the segment 1 is used for path calculation in this state, it is anticipated that the congestion state worsens. Therefore, the path calculation unit selection function part 88 within the external WAN server 14 does not use the information processing unit within the segment 1 as the transmission source of communication for path calculation, but uses information aggregated by the information aggregation unit and selects an information processing unit to be used in path calculation. For example, in a case where it is determined that the amount of information within the segment 3 is small on the basis of the information aggregated by the external WAN server 14, the path calculation unit selection function part 88 selects use of the information processing unit of the segment 3 in path calculation. Then, upon selecting the information processing unit of the segment 3, the path calculation unit selection function part 88 causes the path calculation instruction unit to transmit information necessary for path calculation to the information processing unit within the segment 3, and also gives an instruction to execute path calculation to the information processing unit within the segment 3. This instruction makes it possible to cause a low-load information processing unit to execute path calculation.

Hereafter, the operation in this exemplary embodiment will be described.

As shown in FIG. 24, firstly, the topology information, flow table information and policy information of segments which are potentially used for a communication path is aggregated into the external WAN server 14 by the administrator function parts 42 within the respective segments. In this process, each of the administrator function parts 42 observes the network controlled by the administrator function part 42 and, in a case where the network controlled by the administrator function part 42 is in the failure or congestion state, transmits congestion/failure information to the external WAN server 14 together with the abovementioned information. In the case shown in FIG. 24, information that failure is occurring in the network within the segment 2 is transmitted by the administrator function part in the segment 2 to the external WAN server 14.

The external WAN server 14 lists sequences of the segments from which the information has been aggregated. In this process, the external WAN server 14 eliminates a segment sequence including segments having no contiguous point from among the listed segment sequences by using the topology information aggregated in the external WAN server 14. Moreover, it is also possible to delete a path including a network in the congestion/failure state by using the abovementioned congestion/failure information. Then, a path including less connection points is selected from among sequences of segments which are not in the congestion/failure state and are contiguous with each other. In this path selection, it is possible to narrow paths to one or it is possible to narrow paths to some extent (e.g., about ten) as in the case described in the second exemplary embodiment.

As stated above, in the case shown in FIG. 24, information that the network within the segment 2 is in the failure state is transmitted to the external WAN server 14 by the administrator function part in the segment 2. Thus, the external WAN server 14 selects a segment sequence to be used for path calculation while avoiding a segment sequence which needs to pass through the segment 2 (the network therein).

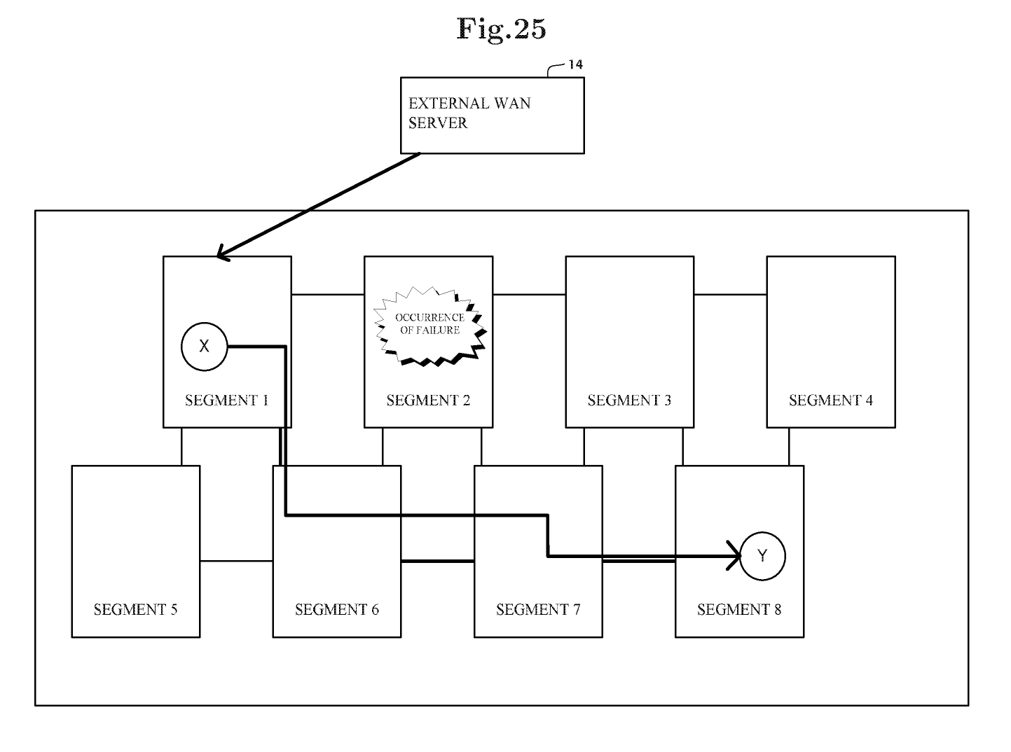

For example, let us suppose a segment sequence including the segment 1, the segment 6, the segment 7 and the segment 8 in this order is selected as shown in FIG. 25. Then, the external WAN server 14 gives an instruction to calculate a communication path passing through the segments 1, 6, 7, 8 to the information processing unit within the segment 1 as shown in FIG. 25. Upon receiving the instruction, as described in the first exemplary embodiment, the information processing unit within the segment 1 executes address resolution and network resolution by using the information stored in the external WAN server 14 in which the information of the networks within the segments 1, 6, 7 and 8 is recorded. The operation described above enables communication from X within the segment 1 to Y within the segment 8.

Further, in a case where the external WAN server 14 narrows segment sequences to a plurality of segment sequences and therefore does not narrow to one, the information processing unit within the segment 1, which has been instructed to calculate a communication path, executes path calculation on each of the plurality of segment sequences. Then, as described in the second exemplary embodiment, the communication path determination unit included by the information processing unit within the segment 1 determines a path to be used for communication.

In the third exemplary embodiment, a case where there are eight segments is described as in the case described in the second exemplary embodiment. However, practice of the present invention is not limited to the case where there are eight segments. For example, the present invention can be practiced even when there are six segments and even when there are 15, 30 or more segments.

The operation as described above makes it possible to calculate a path passing through a plurality of segments while avoiding a communication path in the congestion/failure state.

Although the higher-level path instruction device selection unit is included by the external WAN server 14 in this exemplary embodiment, the higher-level path instruction device selection unit may be included by a component other than the external WAN server 14. For example, the administrator function part 42 may include the higher-level path instruction device selection unit. In this case, the administrator function part 42 is provided with a function of, when congestion/failure information is detected from the network controlled by the administrator function part 42 in execution of path calculation, making another segment (from which congestion/failure information is not detected) execute the path calculation. That is to say, when the administrator function part 42 in the congestion/failure state needs to execute path calculation, the administrator function part 42 in the congestion/failure state contacts the external WAN server 14 to check a segment which is not in the congestion/failure state, and instructs the segment which is not in the congestion/failure state to execute the path calculation (or instructs the segment which is not in the congestion/failure state to execute the path calculation via the external WAN server 14). Thus, by making the administrator function part 42 include the higher-level path instruction device selection unit, it is possible, when a segment including the administrator function part 42 intending to execute path calculation is in the congestion/failure state, to instruct the administrator function part 42 in another segment which is not in the congestion/failure state to execute the path calculation. The higher-level path instruction device selection unit may give the instruction after the congestion/failure state resolution instruction mentioned above. That is to say, the administrator function part 42 may make the instruction to change a segment to execute path calculation in a case where the congestion/failure state is not resolved regardless of the congestion/failure state resolution instruction.

### Fourth Exemplary Embodiment

Next, a communication system according to a fourth exemplary embodiment of the present invention will be described. The communication system according to the fourth exemplary embodiment has the same configuration as in the case where there are a plurality of segments as described in the second and third exemplary embodiments.

The fourth exemplary embodiment shows a case where there are a plurality of ranges each of which is a range where an external WAN server aggregating information from a plurality of segments aggregates information. Let us suppose, in this exemplary embodiment, the external WAN server is provided for every communication carrier. Therefore, the fourth exemplary embodiment is an exemplary embodiment showing a case where there is a need to perform communication through a plurality of carriers. The fourth exemplary embodiment includes, in addition to the components included by the third exemplary embodiment, a higher-level information aggregation server which aggregates information aggregated by the respective external WAN servers (a higher-level information aggregation server is equivalent to an information aggregation unit).

The higher-level information aggregation server aggregates and stores topology information, flow table information, policy information and congestion/failure information aggregated by the respective external WAN servers. For that purpose, the higher-level information aggregation server has a database for recording the respective information. Moreover, the higher-level information aggregation server has a DNS function part and a segment selection function part. The abovementioned external storage device can also be connected thereto.

By using the information described above, the higher-level information aggregation server selects a group to be used for a communication path from among groups from which the respective external WAN servers aggregate the information. A means used in the selection is the same as those shown in the second and third exemplary embodiments. That is to say, it is determined by using topology information whether sections are mutually connected, or a group in the congestion/failure state is omitted by using congestion/failure information. In the fourth exemplary embodiment, it is also possible to set so as not to delete a path from which congestion/failure information is obtained, in a case where the group has only some congestion/failure and it is possible to bypass the congestion/failure in the group and perform communication.

The operation after selection of the group is the same as the operation described in the second and third exemplary embodiments. By using the higher-level information aggregation server described above, it is possible to establish a communication path without any problem even if, for example, there is a need to establish a communication path through a plurality of communication carriers.

Further, this exemplary embodiment shows a case where a plurality of external WAN servers exist. Therefore, an additional configuration is necessary for transmitting a flow entry to each OpenFlow switch and receiving a setting completion notice from the OpenFlow switch to start communication.

To be specific, carrier network IDs (external WAN IDs) are previously assigned to the respective external WAN servers used in this exemplary embodiment. The carrier network IDs do not overlap each other. Further, a communication management function part of each of the external WAN servers includes an ID information storage part which temporarily stores ID information, and an ID comparison part which compares the information stored in the ID information storage part with a setting completion ID showing completion of path setting in all the OpenFlow switches controlled thereby.

The operation from notice of setting completion to start of communication in this exemplary embodiment will be described. First, let us suppose establishment of a path is required with start of communication and path calculation is executed. The operation in this process is as described before. Then, at a stage where a communication path to be used for communication is determined as a result of path calculation (at a state where a flow entry is transmitted to the OpenFlow switches in the respective segments), each of the external WAN servers corresponding to segments to be used for the communication path transmits a carrier network ID assigned to the external WAN server to a communication starting external WAN server which has started the communication. Upon receiving carrier network IDs from the respective WAN servers, the communication starting external WAN server stores the carrier network IDs of the respective external WAN servers to be used for the communication path into the ID information storage part within the communication starting external WAN server. Next, each of the external WAN servers having received setting completion notices from all the OpenFlow switches controlled thereby transmits the carrier network ID of the external WAN server as a setting completion ID to the communication starting external WAN server. Upon receiving the setting completion ID, the communication starting external WAN server causes the ID comparison part to perform comparison of the setting completion ID with the carrier network IDs stored in the ID information storage part. In the case of determining that path setting is complete in all the external WAN servers as a result of the comparison, the communication starting external WAN server instructs start of communication as described above. On the other hand, in a case where the IDs stored in the storage part do not meet the setting completion IDs after a given time passes, the communication starting external WAN server instructs the information processing unit to execute network resolution again.

Through the operation described above, in a case where a plurality of external WAN servers exist, a communication starting external WAN server can instruct start of communication after completion of setting in the respective OpenFlow switches.

Also in the fourth exemplary embodiment, it is possible to provide a higher-level information aggregation server and an information processing unit separately outside.

### Fifth Exemplary Embodiment

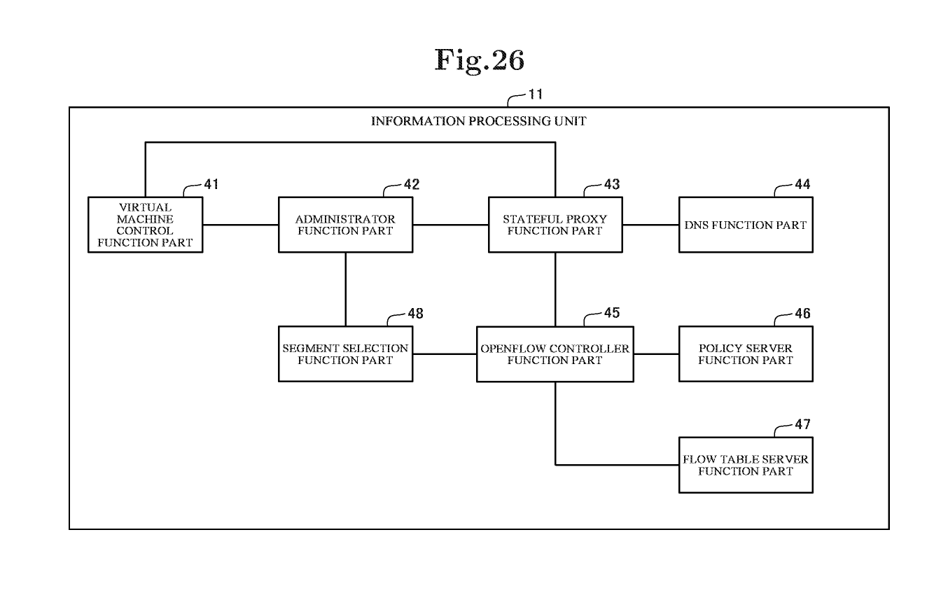

Next, a communication system according to a fifth exemplary embodiment of the present invention will be described with FIG. 26. The communication system according to the fifth exemplary embodiment is another aspect of the communication systems described in the second to fourth exemplary embodiment.

In the second to fourth exemplary embodiments, the external WAN server 14 includes the segment selection function part 86 as shown in FIG. 15, for example. However, as stated before, it can also be conceived not to use the external WAN server 14 (an external server) as the information aggregation unit. In this exemplary embodiment, a case where the external WAN server 14 is not used as the information aggregation unit will be described.

As shown in FIG. 26, the information processing unit 11 in this exemplary embodiment includes the same components as shown in the first to fourth exemplary embodiments. Then, in this exemplary embodiment, the information processing unit 11 further includes a segment selection function part 48.

As stated above, in a case where the external WAN server 14 is not used as the information aggregation unit, the administrator function part 42 included by the information processing unit 11 serves as the information aggregation unit. That is to say, the administrator function part 42, as necessary, acquires network information of another segment from the information processing unit 11 belonging to the other segment via the administrator function part 42 belonging to the other segment. Such a configuration makes the information processing unit 11 serve as the information aggregation unit.

Because the information processing unit 11 in this exemplary embodiment includes the segment selection function part 48, the information processing unit 11 can determine a segment sequence by using the aggregated network information. That is to say, the information processing unit 11 can select a segment sequence to be subjected to path calculation by using the information aggregated by itself, and execute path calculation in accordance with the result of the selection. The selection of a segment sequence is performed in the same manner as in the case where the external WAN server 14 includes the segment selection function part 86 as described before. Therefore, the detailed description will be omitted.

Although this exemplary embodiment describes a case of aggregating network information of another segment without using the external WAN server 14, the external WAN server 14 and the information processing unit 11 may each include a segment selection function part according to the present invention. In this case, a segment sequence may be selected by either the information processing unit 11 or the external WAN server 14.

### <Supplementary Notes>

The whole or part of the exemplary embodiments disclosed above can be described as in the following supplementary notes. Hereinafter, the overview of a communication system according to the present invention will be described. However, the present invention is not limited to the following configurations.

### (Supplementary Note 1)

A communication system, wherein:
a plurality of segments are formed;
the plurality of segments each include: a communication path instruction device instructing a network to establish a communication path; the network in which a communication path is established by the communication path instruction device; and an information acquisition unit acquiring network information of the network; and
networks of the respective segments are connected to each other via a network connection device,

the communication system comprising:
an information aggregation unit aggregating a plurality of the network information acquired by information acquisition units of the respective segments; and
a higher-level communication path instruction unit instructing establishment of a path in each of the networks of the respective segments,

wherein the higher-level communication path instruction unit instructs establishment of a communication path passing through the networks by using the information aggregated by the information aggregation units.

According to this configuration, a plurality of segments are formed, and each of the segments has a communication path instruction device instructing a given network to establish a communication path, a network in which a communication path is established by the communication path instruction device, and an information acquisition unit acquiring network information of the network. In this state, the information of the networks of the respective segments is aggregated by an information aggregation unit, and a higher-level communication path instruction unit can utilize the information aggregated by the information aggregation unit. Consequently, the higher-level communication path instruction unit can establish a communication path passing through a plurality of segments.

### (Supplementary Note 2)

The communication system according to Supplementary Note 1, comprising a segment selection unit selecting the segments to be used for a communication path from among the plurality of segments on a basis of the information aggregated by the information aggregation units, wherein the higher-level communication path instruction unit instructs establishment of a communication path passing through the networks of the segments selected by the segment selection unit.

According to this configuration, the communication system has a segment selection unit. Consequently, for example, when there is a need to pass through a number of segments, a communication path passing through a plurality of networks can be established with more efficiency.

### (Supplementary Note 3)

The communication system according to Supplementary Note 2, wherein:

each of the information acquisition units acquires congestion information of the network belonging to the segment to which the information acquisition unit belongs;

the information aggregation unit aggregates a plurality of the congestion information acquired by the information acquisition units;

the segment selection unit selects the segments to be used for establishment of a path, while avoiding the network in a congestion state exceeding a predetermined level, on a basis of the congestion information collected by the information aggregation unit; and

the higher-level communication path instruction unit instructs establishment of a communication path passing through the networks of the segments selected by the segment selection unit.

According to this configuration, each of the information acquisition units detects congestion information of the network. Then, the congestion information detected by the information acquisition units is aggregated by the information aggregation unit. Consequently, the segment selection unit can select segments while avoiding a segment having a network in the congestion state, and a communication path passing through a significant number of segments can be established with more efficiency.

### (Supplementary Note 4)

The communication system according to Supplementary Note 2 or 3, wherein:

each of the information acquisition units acquires failure information of the network belonging to the segment to which the information acquisition unit belongs;

the information aggregation unit aggregates a plurality of the failure information acquired by the information acquisition units;

the segment selection unit selects the segments to be used for establishment of a path, while avoiding the network in a failure state exceeding a predetermined level, on a basis of the failure information collected by the information aggregation unit; and

the higher-level communication path instruction unit instructs establishment of a communication path passing through the networks of the segments selected by the segment selection unit.

According to this configuration, each of the information acquisition units detects failure information of the network. Then, the congestion information detected by the information acquisition units is aggregated by the information aggregation unit. Consequently, the segment selection unit can select segments while avoiding a segment having a network in the failure state, and a communication path passing through a significant number of segments can be established with more efficiency.

### (Supplementary Note 5)

The communication system according to Supplementary Note 3 or 4, comprising a higher-level path instruction device selection unit selecting one or more communication path instruction devices working as the higher-level communication path instruction unit, from among a plurality of communication path instruction devices provided in the plurality of segments, respectively,

wherein the higher-level path instruction device selection unit selects the one or more communication path instruction devices working as the higher-level communication path instruction unit, while avoiding the communication path instruction device in the segment including the network, on a basis of the plurality of network information acquired by the information acquisition units.

According to this configuration, the communication system has a higher-level path instruction device selection unit selecting one or more communication path instruction devices working as the higher-level communication path instruction unit, from among a plurality of communication path instruction devices provided in the plurality of segments, respectively. Then, the higher-level path instruction device selection unit avoids a communication path instruction device in a segment having a given network, on the basis of the network information acquired by the information acquisition units. This allows selection of a communication path instruction device having the higher-level communication path instruction unit on the basis of the network information. Thus, it becomes possible to select a communication path instruction device having the higher-level communication path instruction unit on the basis of the network information, for example, select a communication path instruction device having the higher-level communication path instruction device so as to avoid a communication path instruction device in the congestion state.

### (Supplementary Note 6)

The communication system according to Supplementary Notes 2 to 5, wherein the segment selection unit:

lists a plurality of used path candidates passing through the networks of the respective segments; and

selects the used path candidate or used path candidates to be used by the higher-level communication path instruction unit for establishment of a communication path, from among the plurality of used path candidates, by using the network information aggregated by the information aggregation unit.

According to this configuration, the network selection unit lists paths of the networks of the respective segments which are potentially used for a communication path. Then, the network selection unit selects one or more paths on which the higher-level communication path instruction device instructs establishment of a communication path, from among the listed paths, by using the network information of the networks in the information aggregation unit. Consequently, it is possible to list paths and then narrow paths in the networks to be subjected to path calculation by using the network information. Thus, a communication path passing through a plurality of networks can be established with more efficiency.

(Supplementary note 7)

The communication system according to Supplementary Notes 2 to 6, wherein the higher-level communication path instruction unit includes the segment selection unit.

According to this configuration, the higher-level communication path instruction unit has the segment selection unit. Consequently, the higher-level communication path instruction unit can establish a communication path after selecting segments to be used for a communication path.

### (Supplementary Note 8)

The communication system according to Supplementary Notes 1 to 7, wherein one or more of a plurality of communication path instruction devices provided in the plurality of segments, respectively, work as the higher-level communication path instruction unit.

According to this configuration, the communication path instruction devices included by the respective networks each have a function as the higher-level communication path instruction unit. Thus, without providing a higher-level communication path instruction device additionally, it is possible to establish a communication path passing through a plurality of networks.

### (Supplementary Note 9)

An information aggregation device used in a state that:
a plurality of segments are formed;
the plurality of segments each include: a communication path instruction device instructing a network to establish a communication path; the network in which a communication path is established by the communication path instruction device; and an information acquisition unit acquiring network information of the network; and
networks of the respective segments are connected to each other via a network connection device,

the information aggregation device comprising:
an information aggregation unit aggregating a plurality of the network information acquired by information acquisition units of the respective segments; and
an aggregated information provision unit providing the aggregated network information to a higher-level communication path instruction unit instructing each of the networks of the respective segments to establish a communication path passing through the networks.

### (Supplementary Note 10)

The information aggregation device according to Supplementary Note 9, comprising a segment selection unit selecting the segments to be used for a communication path from among the plurality of segments on a basis of the information aggregated by the information aggregation unit,

wherein the aggregated information provision unit provides information of the networks selected by the segment selection unit.

### (Supplementary Note 11)

An information processing method in a state that:
a plurality of segments are formed;
the plurality of segments each include: a communication path instruction device instructing a network to establish a communication path; the network in which a communication path is established by the communication path instruction device; and an information acquisition unit acquiring network information of the network; and
networks of the respective segments are connected to each other via a network connection device,

the information processing method comprising:

aggregation by an information aggregation unit, the aggregation being aggregating the network information from the networks of the respective segments; and

instruction by a communication path instruction device, the instruction being instructing establishment of a communication path passing through the networks by using the aggregated network information.

### (Supplementary Note 12)

The information processing method according to Supplementary Note 11, comprising:

selection by the information aggregation unit, the selection being selecting the segments to be used for a communication path from among the plurality of segments at a time of aggregation of the network information from the networks of the respective segments; and

instruction by the communication path instruction device, the instruction being instructing establishment of a communication path passing through the networks of the selected segments.

### (Supplementary Note 13)

A computer program comprising instructions for causing an information aggregation device to realize:

an information aggregation unit aggregating network information of networks of respective segments; and

an aggregated information provision unit providing the aggregated network information to a higher-level communication path instruction unit instructing each of the networks of the respective segments to establish a communication path passing through the networks.

A program described in the exemplary embodiments and Supplementary Notes is stored in a storage device or recorded on a computer-readable recording medium. For example, the recording medium is a portable medium such as a flexible disk, an optical disk, a magneto-optical disk and a semiconductor memory.

Although the present invention has been described above referring to the exemplary embodiments, the present invention is not limited to the exemplary embodiments. The configurations and details of the present invention may be changed and modified in various manners that can be understood by one skilled in the art within the scope of the present invention.

The present invention is based upon and claims the benefit of priority from Japanese patent application No. 2013-138676, filed on Jul. 2, 2013, the disclosure of which is incorporated herein in its entirety by reference.

### DESCRIPTION OF NUMERALS

11 information processing unit
12 network
13 terminal device
14 external WAN server
15 network connection device
21 information processing device
22 network
31 OpenFlow switch
41 virtual machine control function part
42 administrator function part
43 stateful proxy function part
44 DNS function part
45 OpenFlow controller function part
46 policy server function part
47 flow table server function part
48 segment selection function part
51 communication part
52 virtual machine control part
53 virtual machine DB
61 arithmetic part
62 input/output part
63 storage part
64 communication part
65 acquisition part
71 transfer control part
72 flow table DB
73 communication part
81 DNS function part
82 topology information DB
83 flow table information DB
84 policy information DB
85 communication management function part
86 segment selection function part
87 congestion/failure information DB
88 path calculation unit selection function part
91 flow table

What is claimed is:

1. A communication system, wherein:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the communication system comprising:
an information aggregation unit aggregating a plurality of the network information acquired by information acquisition units of the respective segments; and
a higher-level communication path instruction unit instructing establishment of a path in each of the networks of the respective segments,
wherein the higher-level communication path instruction unit instructs establishment of a communication path passing through the networks by using the information aggregated by the information aggregation units.

2. The communication system according to claim 1, comprising a segment selection unit selecting the segments to be used for a communication path from among the plurality of segments on a basis of the information aggregated by the information aggregation units,
wherein the higher-level communication path instruction unit instructs establishment of a communication path passing through the networks of the segments selected by the segment selection unit.

3. The communication system according to claim 2, wherein:
each of the information acquisition units acquires congestion information of the network belonging to the segment to which the information acquisition unit belongs;
the information aggregation unit aggregates a plurality of the congestion information acquired by the information acquisition units;
the segment selection unit selects the segments to be used for establishment of a path, while avoiding the network in a congestion state exceeding a predetermined level, on a basis of the congestion information collected by the information aggregation unit; and
the higher-level communication path instruction unit instructs establishment of a communication path passing through the networks of the segments selected by the segment selection unit.

4. The communication system according to claim 2, wherein:
each of the information acquisition units acquires failure information of the network belonging to the segment to which the information acquisition unit belongs;
the information aggregation unit aggregates a plurality of the failure information acquired by the information acquisition units;
the segment selection unit selects the segments to be used for establishment of a path, while avoiding the network in a failure state exceeding a predetermined level, on a basis of the failure information collected by the information aggregation unit; and
the higher-level communication path instruction unit instructs establishment of a communication path passing through the networks of the segments selected by the segment selection unit.

5. The communication system according to claim 2, comprising a higher-level path instruction device selection unit selecting one or more communication path instruction devices working as the higher-level communication path instruction unit, from among a plurality of communication path instruction devices provided in the plurality of segments, respectively,
wherein the higher-level path instruction device selection unit selects the one or more communication path instruction devices working as the higher-level communication path instruction unit, while avoiding the communication path instruction device in the segment including the network, on a basis of the plurality of network information acquired by the information acquisition units.

6. The communication system according to claim 2, wherein the segment selection unit:
lists a plurality of used path candidates passing through the networks of the respective segments; and
selects the used path candidate or used path candidates to be used by the higher-level communication path instruction unit for establishment of a communication path, from among the plurality of used path candidates, by using the network information aggregated by the information aggregation unit.

7. The communication system according to claim 2, wherein the higher-level communication path instruction unit includes the segment selection unit.

8. The communication system according to claim 1, wherein one or more of a plurality of communication path instruction devices provided in the plurality of segments, respectively, work as the higher-level communication path instruction unit.

9. An information aggregation device used in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the information aggregation device comprising:
an information aggregation unit aggregating a plurality of the network information acquired by information acquisition units of the respective segments; and
an aggregated information provision unit providing the aggregated network information to a higher-level communication path instruction unit instructing each of the networks of the respective segments to establish a communication path passing through the networks.

10. The information aggregation device according to claim 9, comprising a segment selection unit selecting the segments to be used for a communication path from among the plurality of segments on a basis of the information aggregated by the information aggregation unit,
wherein the aggregated information provision unit provides information of the networks selected by the segment selection unit.

11. An information processing method in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the information processing method comprising:
aggregation by an information aggregation unit, the aggregation being aggregating the network information from the networks of the respective segments; and
instruction by a communication path instruction device, the instruction being instructing establishment of a communication path passing through the networks by using the aggregated network information.

12. The information processing method according to claim 11, comprising:
selection by the information aggregation unit, the selection being selecting the segments to be used for a communication path from among the plurality of segments at a time of aggregation of the network information from the networks of the respective segments; and
instruction by the communication path instruction device, the instruction being instructing establishment of a communication path passing through the networks of the selected segments.

13. A non-transitory computer-readable medium storing a program comprising instructions for causing an information aggregation device to realize:
an information aggregation unit aggregating network information of networks of respective segments; and
an aggregated information provision unit providing the aggregated network information to a higher-level communication path instruction unit instructing each of the networks of the respective segments to establish a communication path passing through the networks.
